(19) United States
(12) Patent Application Publication
(10) Pub. No.: US 2022/0185968 A1
(43) Pub. Date: Jun. 16, 2022

(54) MIXED COMPOSITION

(71) Applicant: SUMITOMO CHEMICAL COMPANY, LIMITED, Tokyo (JP)

(72) Inventors: Masayoshi TOKUDA, Osaka-shi (JP); Sayaka SAKURAI, Tokyo (JP)

(73) Assignee: SUMITOMO CHEMICAL COMPANY, LIMITED, Tokyo (JP)

(21) Appl. No.: 17/603,283

(22) PCT Filed: Apr. 1, 2020
(86) PCT No.: PCT/JP2020/015051

§ 371 Date: Oct. 12, 2021

(30) Foreign Application Priority Data
Apr. 23, 2019 (JP) 2019-081433

(51) Int. Cl. C08G 77/62; C09D 183/16; C09D 7/20

(52) U.S. Cl. CPC C08G 77/62; C09D 7/20; C09D 183/16

(57) ABSTRACT

A mixed composition including an organosilicon compound (A) in which at least one trialkylsilyl group-containing molecular chain and at least one hydrolyzable group are bonded to a silicon atom, a metal compound (B), an acid (C), and water (D), in which a ratio [D/(A+B)] of a molar amount of the water (D) to a total molar amount of the organosilicon compound (A) and the metal compound (B) is 3.1 to 130.

### TECHNICAL FIELD

The present invention relates to a mixed composition containing an organosilicon compound and a metal compound.

### BACKGROUND ART

In various display devices, optical elements, semiconductor devices, building materials, automobile parts, nanoimprint technology, and the like, if droplets (in particular, water droplets) adhere to the surface of a base material, the base material can become contaminated or corroded, and moreover problems such as a deterioration in performance caused by such contamination or corrosion can occur. Therefore, in these fields, the surface of the base material needs to have good water repellency and oil repellency. As a composition for forming a coating film in which the surface of the base material can have higher liquid repellency and oil repellency, a mixed composition in which an organosilicon compound is mixed is known.

Patent Literature 1 discloses a coating composition obtained by mixing an organosilicon compound in which at least one trialkylsilyl group-containing molecular chain and at least one hydrolyzable group are bonded to a silicon atom and metal compound in which a hydrolyzable group is bonded to a metal atom. In Patent Literature 1, it is disclosed that the coating film obtained from the coating composition has good water and oil repellency, light resistance, heat resistance and the like.

Patent Literature 2 discloses a mixed composition containing an organosilicon compound having at least one trialkylsilyl group and two or more hydrolyzable silicon groups, and a metal compound in which at least one hydrolyzable group is bonded to a metal atom. Patent Literature 2 discloses that a coating film having good heat resistance and light resistance in addition to water repellency can be provided by using this mixed composition.

However, a coating film obtained using a mixed composition in which an organosilicon compound is mixed may be destroyed by friction or the like, and there are cases in which droplets tend to adhere or in which it is difficult to remove adhered droplets.

Meanwhile, Patent Literature 3 discloses a mixed composition containing an organosilicon compound such as n-decyltrimethoxysilane or tris(trimethoxysilyloxy)siloxy-polydimethylsiloxy-trimethoxysilane, a carboxylic acid compound, and an acid catalyst. In this document, it is disclosed that when the organosilicon compound is n-decyltrimethoxysilane, the wear resistance of the coating film is improved.

### CITATION LIST

### Patent Literature

Patent Literature 1

International Publication No. 2016/068138
Patent Literature 2

Japanese Patent Laid-Open No. 2017-119849
Patent Literature 3

Japanese Patent Laid-Open No. 2018-172660

### SUMMARY OF INVENTION

### Technical Problem

However, there is a need for further improvement in wear resistance.

The present invention focuses on the above-described situation, and it is an object of the present invention to provide a composition capable of realizing a coating film that has excellent water and oil repellency, and that also has excellent wear resistance.

### Solution to Problem

The present invention includes the following inventions.
[1] A mixed composition comprising an organosilicon compound (A) in which at least one trialkylsilyl group-containing molecular chain and at least one hydrolyzable group are bonded to a silicon atom, a metal compound (B), an acid (C), and water (D), wherein a ratio [D/(A+B)] of a molar amount of the water (D) to a total molar amount of the organosilicon compound (A) and the metal compound (B) is 3.1 to 130.
[2] The mixed composition according to [1], wherein an amount of the water (D) is 0.01 to 2.0% by mass.
[3] The composition according to [1] or [2], wherein the organosilicon compound (A) is a compound represented by the following formula (a1):

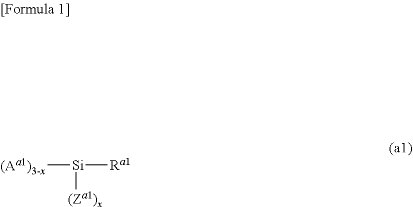

wherein each of a plurality of A^{a1} independently represents a hydrolyzable group, Z^{a1} represents a trialkylsilyl group-containing molecular chain, a siloxane skeleton-containing group, or a hydrocarbon chain-containing group, x is 0 or 1, R^{a1} represents a trialkylsilyl group-containing molecular chain, and a hydrogen atom included in the trialkylsilyl group of Z^{a1} and R^{a1} is optionally replaced by a fluorine atom.
[4] The mixed composition according to any one of [1] to [3], wherein the organosilicon compound (A) is a compound represented by the following formula (a2):

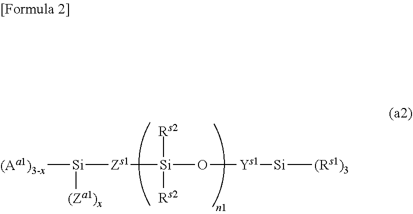

wherein A^{a1}, Z^{a1}, and x have the same meaning as described above, Z^{s1} represents —O— or a divalent hydrocarbon group, —CH₂— included in the divalent hydrocarbon group is optionally replaced by —O—, each of a plurality of R^{s2} independently represents an alkyl group having 1 to 10 carbon atoms, n1 is an integer of 1 or more, Y^{s1} represents a single bond or —Si(R^{s2})₂-L^{s1}-, the L^{s1} represents a divalent hydrocarbon group, —CH₂— included in the divalent hydrocarbon group is optionally replaced by —O—, and each of a plurality of R^{s1} independently represents a hydrocarbon group or a trialkylsilyloxy group.
[5] The mixed composition according to any one of [1] to [4], wherein the metal compound (B) is a compound represented by the following formula (b1):

M(R^{b10})ᵣ(A^{b1})ₘ₋ᵣ (b1)

wherein M represents Al, Fe, In, Ge, Hf, Si, Ti, Sn, Zr, or Ta, R^{b10} represents a siloxane skeleton-containing group, a hydrocarbon chain-containing group, or a hydrogen atom, r is 0 or 1, a plurality of A^{b1} each independently represent a hydrolyzable group, and m, which is a valence of the metal atom M, denotes an integer selected from 3 to 5.
[6] The mixed composition according to any one of [1] to [5], wherein the metal compound (B) is a compound represented by the following formula (b2):

Si(OR^{b11})_{y}H_{4-y} (b2)

wherein R^{b11} represents an alkyl group having 1 to 6 carbon atoms, and y is 3 or 4.
[7] The mixed composition according to any one of [1] to [6], comprising a solvent (E), wherein an amount of the solvent (E) is 10% by mass or more.

It is noted that the term “mixed composition” includes compositions in which, after mixing, for example, a reaction has proceeded during storage. In the following, the term “mixed composition” may sometimes be referred to simply as “composition”.

### Advantageous Effects of Invention

A coating film obtained using the mixed composition of the present invention has good water and oil repellency and good wear resistance.

### DESCRIPTION OF EMBODIMENTS

Hereinafter, the organosilicon compound (A), the metal compound (B), the acid (C), and the water (D) will be described in order.

### 1. Organosilicon Compound (A)

In the organosilicon compound (A) in the present invention, at least one trialkylsilyl group-containing molecular chain and at least one hydrolyzable group are bonded to a central silicon atom.

The trialkylsilyl group-containing molecular chain is a monovalent group having a structure in which a trialkylsilyl-containing group is bonded to an end of the molecular chain. As a result of the trialkylsilyl-containing group bonding to the molecular chain, the water and oil repellency of the coating film formed from the composition of the present invention is improved, and in particular, the sliding properties of water droplets is improved. Further, the presence of the trialkylsilyl group-containing molecular chain reduces the friction between the droplets (water droplets or the like) and the coating film, and facilitates the movement of the droplets. Even when the alkyl group of the trialkylsilyl-containing group is replaced by a fluoroalkyl group, the water and oil repellency (in particular, the sliding properties of water droplets) of the coating film interface (surface) can be similarly improved.

The number of carbon atoms of the alkyl group included in the trialkylsilyl-containing group is preferably 1 to 4, more preferably 1 to 3, and further preferably 1 or 2.

In the trialkylsilyl group-containing molecular chain, the molecular chain to which the trialkylsilyl-containing group is bonded is preferably a straight chain or a branched chain, and more preferably is a straight chain.

The molecular chain to which the trialkylsilyl-containing group is bonded preferably includes a dialkylsiloxane chain, and more preferably includes a straight dialkylsiloxane chain. Further, the molecular chain including a dialkylsiloxane chain may include a divalent hydrocarbon group. Even if a part of the molecular chain is a divalent hydrocarbon group, the rest is a dialkylsiloxane chain, and therefore the obtained coating film has good chemical and physical durability.

In the organosilicon compound (A), the number of trialkylsilyl group-containing molecular chains bonded to the central silicon atom is 1 or more, and is preferably 3 or less, and more preferably 2 or less. The number of trialkylsilyl group-containing molecular chains bonded to the central silicon atom is particularly preferably 1.

The hydrolyzable group is a group that gives a hydroxy group (group that bonds to a silicon atom to form a silanol group) by hydrolysis. Preferable examples thereof include an alkoxy group having 1 to 4 carbon atoms, such as a methoxy group, an ethoxy group, a propoxy group, and a butoxy group; a hydroxy group; an acetoxy group; a chlorine atom; an isocyanate group; and the like. Among these, an alkoxy group having 1 to 4 carbon atoms is preferable, and an alkoxy group having 1 or 2 carbon atoms is more preferable.

In the organosilicon compound (A), the number of hydrolyzable groups bonded to the central silicon atom is 1 or more, preferably 2 or more, and is usually preferably 3 or less.

The central silicon atom of the organosilicon compound (A) may have bonded thereto, in addition to the trialkylsilyl group-containing molecular chain and the hydrolyzable group, a siloxane skeleton-containing group (preferably, a siloxane skeleton-containing groups having fewer atoms than the number of atoms constituting the molecular chain of the trialkylsilyl group-containing molecular chain), or a hydrocarbon chain-containing group (preferably, a hydrocarbon chain-containing group containing a hydrocarbon chain having fewer carbon atoms than the number of atoms constituting the molecular chain of the trialkylsilyl group-containing molecular chain).

The composition of the present invention may include two or more types of the organosilicon compound (A).

Specifically, the organosilicon compound (A) is preferably a compound represented by the following formula (a1).

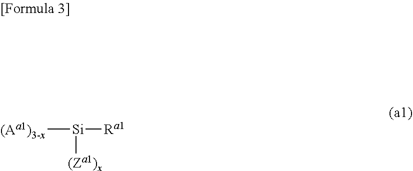

In formula (a1) , each of a plurality of A^{a1} independently represents a hydrolyzable group, Z^{a1} represents a trialkylsilyl group-containing molecular chain, a siloxane skeleton-containing group, or a hydrocarbon chain-containing group, x is 0 or 1, R^{a1} represents a trialkylsilyl group-containing molecular chain, and a hydrogen atom included in the trialkylsilyl group of Z^{a1} and R^{a1} is optionally replaced by a fluorine atom.

In formula (a1), each of the plurality of A^{a1} may independently be a group that gives a hydroxy group (group that bonds to a silicon atom to form a silanol group) by hydrolysis. Preferable examples thereof include an alkoxy group having 1 to 4 carbon atoms, such as a methoxy group, an ethoxy group, a propoxy group, and a butoxy group; a hydroxy group; an acetoxy group; a chlorine atom; an isocyanate group; and the like. Among these, an alkoxy group having 1 to 4 carbon atoms is preferable, and an alkoxy group having 1 or 2 carbon atoms is more preferable.

In formula (a1), R^{a1} is a trialkylsilyl group-containing molecular chain, and as described above, is a monovalent group having a structure in which the trialkylsilyl-containing group is bonded to an end of the molecular chain. The trialkylsilyl-containing group is a group that includes at least one trialkylsilyl group, preferably two or more trialkylsilyl groups, and more preferably three trialkylsilyl groups.

The trialkylsilyl-containing group is preferably a group represented by the following formula (s1).

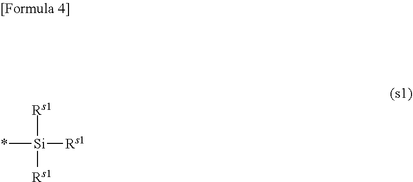

In formula (s1), each of a plurality of R^{s1} independently represents a hydrocarbon group or a trialkylsilyloxy group, a hydrogen atom included in the hydrocarbon group or the trialkylsilyloxy group is optionally replaced by a fluorine atom, and * represents a bond.

When the R^{s1}s are hydrocarbon groups, the number of carbon atoms thereof is preferably 1 to 4, more preferably 1 to 3, and further preferably 1 or 2.

When the R^{s1}s are hydrocarbon groups, an aliphatic hydrocarbon group is preferable, and an alkyl group is more preferable. Examples of the alkyl group include a methyl group, an ethyl group, a propyl group, a butyl group, and the like.

In formula (s1), it is preferable that at least one R^{s1} is a trialkylsilyloxy group, or that all of the R^{s1}s are alkyl groups.

The plurality of R^{s1}s may be the same or different, but are preferably the same.

When all the R^{s1}s are hydrocarbon groups (in particular, alkyl groups), the total number of carbon atoms of three R^{s1}s is preferably 9 or less, more preferably 6 or less, and further preferably 4 or less. It is preferable that at least one of the three R^{s1}s is a methyl group, more preferably that at least two are methyl groups, and particularly preferably that all three R^{s1}s are methyl groups.

Specific examples of the group (trialkylsilyl group) in which all of the R^{s1}s are hydrocarbon groups (alkyl groups) include groups represented by the following formulas. In the formula, * represents a bond.

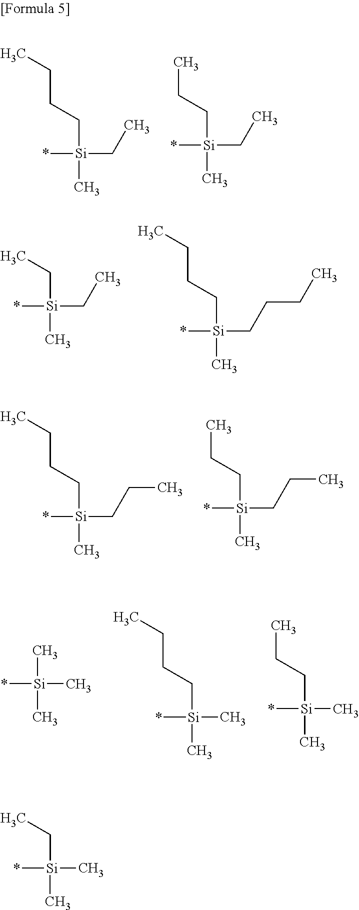

Further, in formula (s1), when at least one R^{s1} is a trialkylsilyloxy group, examples of the trialkylsilyloxy group include a group in which an oxygen atom is bonded to the silicon atom of a group (trialkylsilyl group) in which all of the R^{s1}s are hydrocarbon groups (alkyl groups). In formula (s1), it is preferable that two or more R^{s1}s are trialkylsilyloxy groups, and more preferably that three R^{s1}s are trialkylsilyloxy groups.

Examples of the group in which at least one R^{s1} is a trialkylsilyloxy group include groups represented by the following formulas.

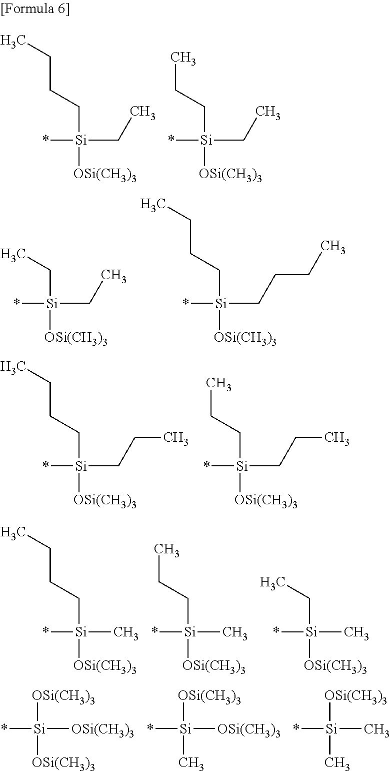

In the trialkylsilyl group-containing molecular chain, the trialkylsilyl-containing group is preferably bonded to an end (free end side) of the molecular chain, and particularly to an end (free end side) of the main chain (longest straight chain) of the molecular chain.

The molecular chain to which the trialkylsilyl-containing group is bonded is preferably a straight or branched chain, and more preferably a straight chain.

The molecular chain to which the trialkylsilyl-containing group is bonded preferably includes a dialkylsiloxane chain, and more preferably a straight dialkylsiloxane chain. Further, the molecular chain including the dialkylsiloxane chain may include a divalent hydrocarbon group. Even if a part of the molecular chain is a divalent hydrocarbon group, the rest is a dialkylsiloxane chain, and therefore the obtained coating film has good chemical and physical durability.

The molecular chain to which the trialkylsilyl-containing group is bonded is preferably a group represented by the following formula (s2).

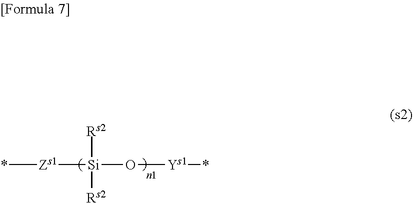

In formula (s2), Z^{s1} represents —O— or a divalent hydrocarbon group, —CH₂— included in the divalent hydrocarbon group is optionally replaced by —O—, each of a plurality of R^{s2} independently represents an alkyl group having 1 to 10 carbon atoms, n1 is an integer of 1 or more, Y^{s1} represents a single bond or —Si(R^{s2})₂-L^{s1}-, the L^{s1} represents a divalent hydrocarbon group, —CH₂— included in the divalent hydrocarbon group is optionally replaced by —O—, * on the left side of formula (s2) represents a bond with a central silicon atom, and * on the right side of formula (s2) represents a bond with a trialkylsilyl-containing group.

The number of carbon atoms of the alkyl group represented by R^{s2} is preferably 1 to 4, more preferably 1 to 3, and further preferably 1 or 2.

n1 is preferably an integer of 1 to 100, more preferably an integer of 1 to 80, further preferably an integer of 1 to 60, particularly preferably an integer of 1 to 50, and most preferably an integer of 1 to 30.

The number of carbon atoms of the divalent hydrocarbon group represented by Z^{s1} or L^{s1} is preferably 1 to 10, more preferably 1 to 6, and further preferably 1 to 4. The divalent hydrocarbon group is preferably in the form of a chain, and when it is in the form of a chain, the divalent hydrocarbon group may be in the form of straight or branched chain. The divalent hydrocarbon group is preferably a divalent aliphatic hydrocarbon group, and preferably an alkanediyl group. Examples of the divalent hydrocarbon group include a methylene group, an ethylene group, a propylene group, a butylene group, and the like.

Further, some of the —CH₂— included in the divalent hydrocarbon group may be replaced by —O—. In this case, two consecutive —CH₂— are not replaced by —O— at the same time, and a —CH₂— adjacent to the Si atom is not replaced by —O—. When two or more —CH₂— are replaced by —O—, the number of carbon atoms between —O— and —O— is preferably 2 to 4, and more preferably 2 or 3. Specific examples of the group in which some of the divalent hydrocarbon groups are replaced by —O— include a group having a (poly)ethylene glycol unit, a group having a (poly)propylene glycol unit, and the like.

In formula (s2), it is preferable that Z^{s1} is —O— and Y^{s1} is a single bond, that is, the molecular chain consists only of repeating dialkylsilyloxy groups. When the dialkylsiloxane chain consists only of repeating dialkylsilyloxy groups, the obtained coating film has good chemical and physical durability.

Examples of the molecular chain included in the trialkylsilyl group-containing molecular chain include the molecular chains represented by the following formulas. In the following formulas, q1 represents an integer of 1 or more, and * represents a bond that binds to the central silicon atom or the trialkylsilyl-containing group. q1 has the same numerical range as n1, and the preferred ranges are also the same.

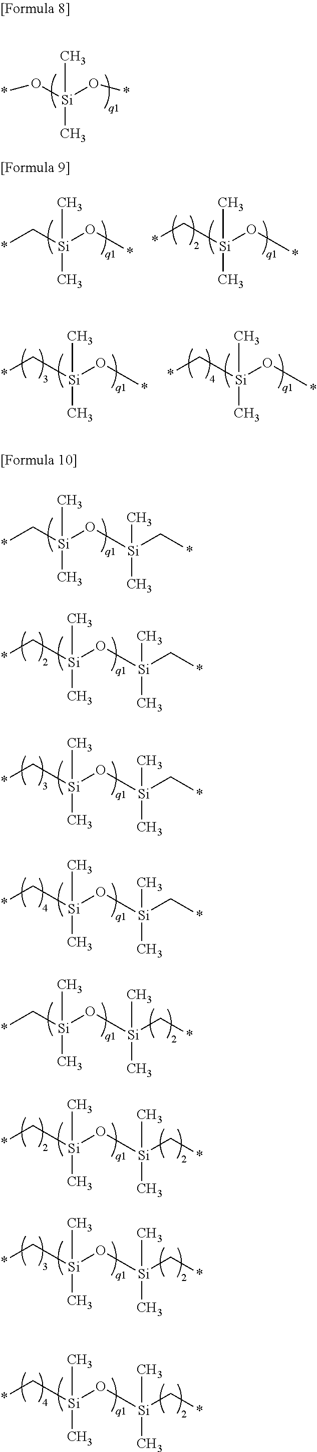

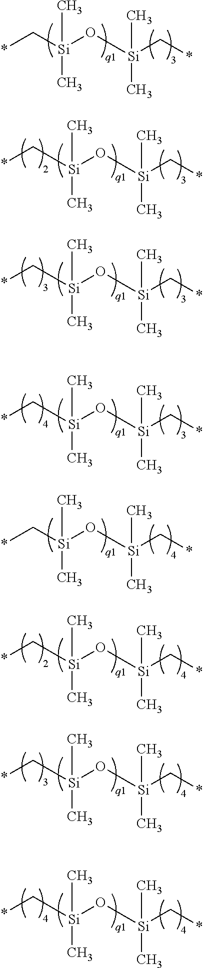

Further, the total number of atoms constituting the trialkylsilyl group-containing molecular chain is preferably 24 or more, more preferably 40 or more, and further preferably 50 or more, and is preferably 5000 or less, more preferably 4000 or less, further preferably 2000 or less, still further preferably 1200 or less, particularly preferably 700 or less, and most preferably 250 or less.

The trialkylsilyl group-containing molecular chain is preferably a group represented by the following formula (s3).

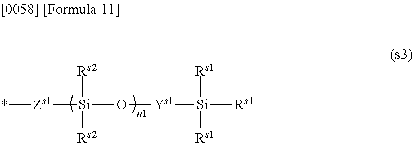

In formula (s3) , Z^{s1}, R^{s2}, n1, Y^{s1}, and R^{s1} have the same meaning as described above, and * represents a bond with the central silicon atom.

The trialkylsilyl group-containing molecular chain is preferably a group represented by the following formula (s3-1) or the following formula (s3-2), and more preferably a group represented by the following formula (s3-2).

When the trialkylsilyl group-containing molecular chain is represented by the following formula (s3-1), a group represented by the following formula (s3-1-1) is more preferable.

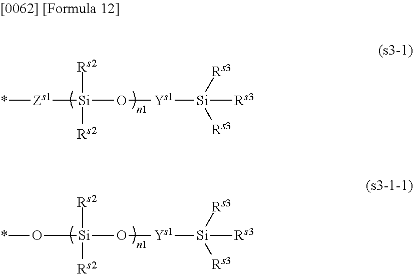

In formula (s3-1) and formula (s3-1-1) , Z^{s1}, R^{s2}, n1, and Y^{s1} have the same meaning as described above, R^{s3} represents an alkyl group having 1 to 4 carbon atoms, and * represents a bond with the central silicon atom.

The number of carbon atoms of the alkyl group represented by R^{s3} is preferably 1 to 3, and more preferably 1 or 2. Further, in formula (s3-1) and formula (s3-1-1), the total number of carbon atoms of the R^{s3} included in —Si(R^{s3})₃ is preferably 9 or less, more preferably 6 or less, and further preferably 4 or less. In addition, of the R^{s3}s included in —Si(R^{s3})₃, it is preferable that at least one R^{s3} is a methyl group, more preferable that two or more R^{s3}s are methyl groups, and particularly preferable that all three R^{s3}s are methyl groups.

When the trialkylsilyl group-containing molecular chain is represented by the following formula (s3-2), a group represented by the following formula (s3-2-1) is more preferable.

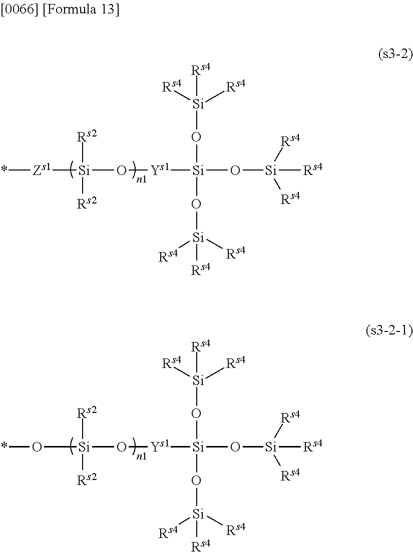

In formula (s3-2) and formula (s3-2-1), Z^{s1}, R^{s2}, n1, and Y^{s1} have the same meaning as described above, R^{s4} represents an alkyl group having 1 to 4 carbon atoms, and * represents a bond with the central silicon atom.

Examples of the alkyl group having 1 to 4 carbon atoms represented by R^{s4} include the groups described above for R^{s3}, and the preferred range is also the same.

The number of carbon atoms of the alkyl group represented by R^{s4} is preferably 1 to 3, and more preferably 1 or 2. Further, the total number of carbon atoms of the R^{s4} included in —Si(R^{s4})₃ is preferably 9 or less, more preferably 6 or less, and further preferably 4 or less. In addition, of the R^{s4}s included in —Si(R^{s4})₃, it is preferable that at least one R^{s4} is a methyl group, more preferable that two or more R^{s4}s are methyl groups, and particularly preferable that all three R^{s4}s are methyl groups.

Specific examples of the trialkylsilyl group-containing molecular chain include a group represented by the following formula (s3-I).

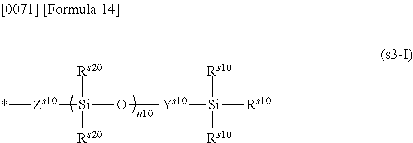

In formula (s3-I), * represents a bond with the central silicon atom.

In formula (s3-I) , Z^{s10}, R^{s20}, n10, Y^{s10}, and R^{s10} are preferably combined as shown in Tables 1 and 2 below.

TABLE 1

| | Z^{s10} | R^{s20} | n10 | Y^{s10} | R^{s10} |
|---|---|---|---|---|---|
| (s3-I-1) | *—O—* | CH₃—* | 1~60 | — | (CH₃)₃SiO—* |
| (s3-I-2) | *—O—* | CH₃—* | 1~60 | *—Si(CH₃)₂—CH₂—* | (CH₃)₃SiO—* |
| (s3-I-3) | *—O—* | CH₃—* | 1~60 | * Si(CH₃)₂—(CH₂)₂—* | (CH₃)₃SiO—* |
| (s3-I-4) | *—O—* | CH₃—* | 1~60 | *—Si(CH₃)₂—(CH₂)₃—* | (CH₃)₃SiO—* |
| (s3-I-5) | *—O—* | CH₃—* | 1~60 | *—Si(CH₃)₂—(CH₂)₄—* | (CH₃)₃SiO—* |
| (s3-I-6) | *—CH₂—* | CH₃—* | 1~60 | — | (CH₃)₃SiO—* |
| (s3-I-7) | *—CH₂—* | CH₃—* | 1~60 | *—Si(CH₃)₂—CH₂—* | (CH₃)₃SiO—* |
| (s3-I-8) | *—CH₂—* | CH₃—* | 1~60 | *—Si(CH₃)₂—(CH₂)₂—* | (CH₃)₃SiO—* |
| (s3-I-9) | *—CH₂—* | CH₃—* | 1~60 | *—Si(CH₃)₂—(CH₂)₃—* | (CH₃)₃SiO—* |
| (s3-I-10) | *—CH₂—* | CH₃—* | 1~60 | *—Si(CH₃)₂—(CH₂)₄—* | (CH₃)₃SiO—* |
| (s3-I-11) | *—(CH₂)₂—* | CH₃—* | 1~60 | — | (CH₃)₃SiO—* |
| (s3-I-12) | *—(CH₂)₂—* | CH₃—* | 1~60 | *—Si(CH₃)₂—CH₂—* | (CH₃)₃SiO—* |
| (s3-I-13) | *—(CH₂)₂—* | CH₃—* | 1~60 | *—Si(CH₃)₂—(CH₂)₂—* | (CH₃)₃SiO—* |
| (s3-I-14) | *—(CH₂)₂—* | CH₃—* | 1~60 | *—Si(CH₃)₂—(CH₂)₃—* | (CH₃)₃SiO—* |
| (s3-I-15) | *—(CH₂)₂—* | CH₃—* | 1~60 | *—Si(CH₃)₂—(CH₂)₄—* | (CH₃)₃SiO—* |
| (s3-I-16) | *—(CH₂)₃—* | CH₃—* | 1~60 | — | (CH₃)₃SiO—* |
| (s3-I-17) | *—(CH₂)₃—* | CH₃—* | 1~60 | *—Si(CH₃)₂—CH₂—* | (CH₃)₃SiO—* |
| (s3-I-18) | *—(CH₂)₃—* | CH₃—* | 1~60 | *—Si(CH₃)₂—(CH₂)₂—* | (CH₃)₃SiO—* |
| (s3-I-19) | *—(CH₂)₃—* | CH₃—* | 1~60 | *—Si(CH₃)₂—(CH₂)₃—* | (CH₃)₃SiO—* |
| (s3-I-20) | *—(CH₂)₃—* | CH₃—* | 1~60 | *—Si(CH₃)₂—(CH₂)₄—* | (CH₃)₃SiO—* |
| (s3-I-21) | *—(CH₂)₄—* | CH₃—* | 1~60 | — | (CH₃)₃SiO—* |
| (s3-I-22) | *—(CH₂)₄—* | CH₃—* | 1~60 | *—Si(CH₃)₂—CH₂—* | (CH₃)₃SiO—* |
| (s3-I-23) | *—(CH₂)₄—* | CH₃—* | 1~60 | *—Si(CH₃)₂—(CH₂)₂—* | (CH₃)₃SiO—* |
| (s3-I- 24) | *—(CH₂)₄—* | CH₃—* | 1~60 | *—Si(CH₃)₂—(CH₂)₃—* | (CH₃)₃SiO—* |
| (s3-I-25) | *—(CH₂)₄—* | CH₃—* | 1~60 | *—Si(CH₃)₂—(CH₂)₄—* | (CH₃)₃SiO—* |

TABLE 2

| | Z^{s10} | R^{s20} | n10 | Y^{s10} | R^{s10} |
|---|---|---|---|---|---|
| (s3-I-26) | *—O—* | CH₃—* | 1~60 | — | CH₃—* |
| (s3-I-27) | *—O—* | CH₃—* | 1~60 | *—Si(CH₃)₂—CH₂—* | CH₃—* |
| (s3-I-28) | *—O—* | CH₃—* | 1~60 | * Si(CH₃)₂—(CH₂)₂—* | CH₃—* |
| (s3-I-29) | *—O—* | CH₃—* | 1~60 | *—Si(CH₃)₂—(CH₂)₃—* | CH₃—* |
| (s3-I-30) | *—O—* | CH₃—* | 1~60 | *—Si(CH₃)₂—(CH₂)₄—* | CH₃—* |
| (s3-I-31) | *—CH₂—* | CH₃—* | 1~60 | — | CH₃—* |
| (s3-I-32) | *—CH₂—* | CH₃—* | 1~60 | *—Si(CH₃)₂—CH₂—* | CH₃—* |
| (s3-I-33) | *—CH₂—* | CH₃—* | 1~60 | *—Si(CH₃)₂—(CH₂)₂—* | CH₃—* |
| (s3-I-34) | *—CH₂—* | CH₃—* | 1~60 | *—Si(CH₃)₂—(CH₂)₃—* | CH₃—* |
| (s3-I-35) | *—CH₂—* | CH₃—* | 1~60 | *—Si(CH₃)₂—(CH₂)₄—* | CH₃—* |
| (s3-I-36) | *—(CH₂)₂—* | CH₃—* | 1~60 | — | CH₃—* |
| (s3-I-37) | *—(CH₂)₂—* | CH₃—* | 1~60 | *—Si(CH₃)₂—CH₂—* | CH₃—* |
| (s3-I-38) | *—(CH₂)₂—* | CH₃—* | 1~60 | *—Si(CH₃)₂—(CH₂)₂—* | CH₃—* |
| (s3-I-39) | *—(CH₂)₂—* | CH₃—* | 1~60 | *—Si(CH₃)₂—(CH₂)₃—* | CH₃—* |
| (s3-I-40) | *—(CH₂)₂—* | CH₃—* | 1~60 | *—Si(CH₃)₂—(CH₂)₄—* | CH₃—* |
| (s3-I-41) | *—(CH₂)₃—* | CH₃—* | 1~60 | — | CH₃—* |
| (s3-I-42) | *—(CH₂)₃—* | CH₃—* | 1~60 | *—Si(CH₃)₂—CH₂—* | CH₃—* |
| (s3-I-43) | *—(CH₂)₃—* | CH₃—* | 1~60 | *—Si(CH₃)₂—(CH₂)₂—* | CH₃—* |
| (s3-I-44) | *—(CH₂)₃—* | CH₃—* | 1~60 | *—Si(CH₃)₂—(CH₂)₃—* | CH₃—* |
| (s3-I-45) | *—(CH₂)₃—* | CH₃—* | 1~60 | *—Si(CH₃)₂—(CH₂)₄—* | CH₃—* |
| (s3-I-46) | *—(CH₂)₄—* | CH₃—* | 1~60 | — | CH₃—* |
| (s3-I-47) | *—(CH₂)₄—* | CH₃—* | 1~60 | *—Si(CH₃)₂—CH₂—* | CH₃—* |
| (s3-I-48) | *—(CH₂)₄—* | CH₃—* | 1~60 | *—Si(CH₃)₂—(CH₂)₂—* | CH₃—* |
| (s3-I-49) | *—(CH₂)₄—* | CH₃—* | 1~60 | *—Si(CH₃)₂—(CH₂)₃—* | CH₃—* |
| (s3-I-50) | *—(CH₂)₄—* | CH₃—* | 1~60 | *—Si(CH₃)₂—(CH₂)₄—* | CH₃—* |

The n10 shown in Tables 1 and 2 is preferably 1 to 30.

Further, in formula (a1), Z^{a1} represents a trialkylsilyl group-containing molecular chain, a siloxane skeleton-containing group, or a hydrocarbon chain-containing group.

When Z^{a1} is a trialkylsilyl group-containing molecular chain, examples may include the same as those described above for R^{a1}.

When Z^{a1} is a siloxane skeleton-containing group, it is preferable that the siloxane skeleton-containing group be a monovalent group containing a siloxane unit (Si—O—), and be constituted from a fewer number of atoms than the number of atoms constituting the trialkylsilyl group-containing molecular chain of R^{a1}. As a result, the siloxane skeleton-containing group becomes a group having a shorter length or a smaller steric size (bulk) than the trialkylsilyl group-containing molecular chain. The siloxane skeleton-containing group may include a divalent hydrocarbon group.

The siloxane skeleton-containing group is preferably a group represented by the following formula (s4).

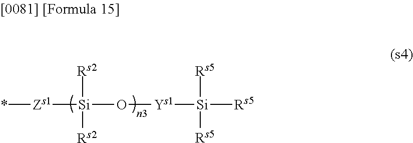

In formula (s4) , Z^{s1}, R^{s2}, and Y^{s1} have the same meaning as described above, R^{s5} represents a hydrocarbon group or a hydroxy group, the —CH₂— included in the hydrocarbon group are optionally replaced by —O—, a hydrogen atom included in the hydrocarbon group is optionally replaced by a fluorine atom, n3 represents an integer of 0 to 5, and * represents a bond with the central silicon atom.

Examples of the hydrocarbon group represented by R^{s5} include the same groups as those of the hydrocarbon group represented by R^{s1}. Preferably, the hydrocarbon group is an aliphatic hydrocarbon group, and more preferably an alkyl group.

The number of carbon atoms of the hydrocarbon group represented by R^{s5} is preferably 1 to 4, more preferably 1 to 3, and further preferably 1 or 2.

n3 is preferably an integer of 1 to 5, and more preferably an integer of 1 to 3.

The total number of atoms of the siloxane skeleton-containing group is preferably 600 or less, more preferably 500 or less, further preferably 350 or less, still further preferably 100 or less, particularly preferably 50 or less, and most preferably 30 or less, and is preferably 10 or more. The difference in the number of atoms between the trialkylsilyl group-containing molecular chain of R^{a1} and the siloxane skeleton-containing group of Z^{a1} is preferably 10 or more, and more preferably 20 or more, and is preferably 1000 or less, more preferably 500 or less, and further preferably 200 or less.

Specific examples of the siloxane skeleton-containing group include a group represented by the following formula.

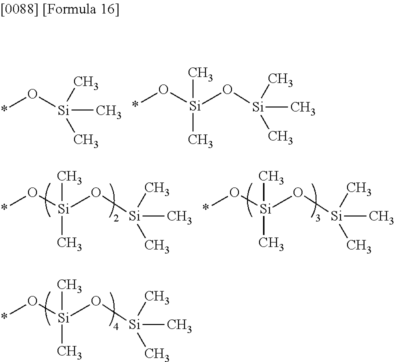

When Z^{a1} is a hydrocarbon chain-containing group, it is preferable that the number of carbon atoms of the hydrocarbon chain moiety is fewer than the number of atoms constituting the molecular chain of the trialkylsilyl group-containing molecular chain in R^{a1}. Further, it is preferable that the number of carbon atoms of the longest straight chain of the hydrocarbon chain is fewer than the number of atoms constituting the longest straight chain of the trialkylsilyl group-containing molecular chain. The term hydrocarbon chain-containing group means a group having a hydrocarbon group in at least a portion thereof. Usually, the hydrocarbon chain-containing group is composed of only hydrocarbon groups (hydrocarbon chains), but if necessary, the hydrocarbon chain-containing group may be a group in which some of the methylene groups (—CH₂—) of the hydrocarbon chain are replaced by oxygen atoms. Further, a methylene group (—CH₂—) adjacent to the Si atom is not replaced by an oxygen atom, and two consecutive methylene groups (—CH₂—) are not replaced by oxygen atoms at the same time.

The number of carbon atoms of the hydrocarbon chain moiety means, for a non-oxygen-substituted hydrocarbon chain-containing group, the number of carbon atoms constituting the hydrocarbon group (hydrocarbon chain), and for an oxygen-substituted hydrocarbon chain-containing group, the number of carbon atoms constituting the hydrocarbon group (hydrocarbon chain) counted by assuming that the oxygen atoms methylene groups (—CH₂—).

Hereinafter, unless otherwise specified, the hydrocarbon chain-containing group is described based on the example of a non-oxygen-substituted hydrocarbon chain-containing group (that is, a monovalent hydrocarbon group) as an example, but in the entire description below, it is possible to replace some of the methylene groups —CH₂— by oxygen atoms.

When the hydrocarbon chain-containing group is a hydrocarbon group, the hydrocarbon chain-containing group preferably has 1 or more and 3 or less carbon atoms, and more preferably 1 carbon atom. Further, the hydrocarbon chain-containing group may be a branched chain or a straight chain. The hydrocarbon chain-containing group is preferably a saturated or unsaturated aliphatic hydrocarbon chain-containing group, and more preferably a saturated aliphatic hydrocarbon chain-containing group. As the saturated aliphatic hydrocarbon chain-containing group, a saturated aliphatic hydrocarbon group is more preferable. Examples of the saturated aliphatic hydrocarbon group include a methyl group, an ethyl group, a propyl group, and the like.

When some of the methylene groups (—CH₂—) of the saturated aliphatic hydrocarbon group are replaced by oxygen atoms, specific examples include a group having a (poly)ethylene glycol unit.

In formula (a1), x is preferably 0.

The organosilicon compound (A) is preferably a compound represented by the following formula (a2).

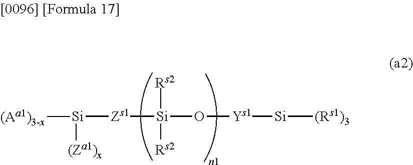

In formula (a2) , A^{a1}, Z^{a1}, x, Z^{s1}, R^{s2}, n1, Y^{s1}, and R^{s1} each have the same meaning as described above.

In formula (a2), n1 is preferably an integer of 1 to 60, is more preferably an integer of 2 or more, and further preferably an integer of 3 or more, and is more preferably an integer of 50 or less, further preferably an integer of 40 or less, particularly preferably an integer of 30 or less, and most preferably an integer of 25 or less.

The organosilicon compound (A) represented by formula (a2) is preferably represented by the following formula (a2-1) or the following formula (a2-2), and more preferably is represented by the following formula (a2-2).

When the organosilicon compound (A) represented by formula (a2) is represented by the following formula (a2-1), a compound represented by the following formula (a2-1-1) is more preferable.

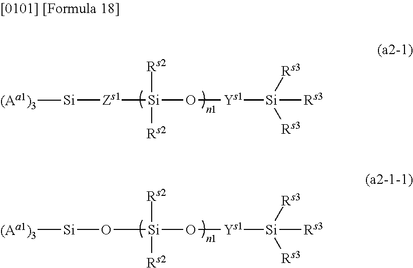

In formula (a2-1) and formula (a2-1-1), A^{a1}, Z^{s1}, R^{s2}, n1, Y^{s1} , and R^{s3} have the same meaning as described above.

When the organosilicon compound (A) represented by formula (a2) is represented by the following formula (a2-2), a compound represented by the following formula (a2-2-1) is more preferable.

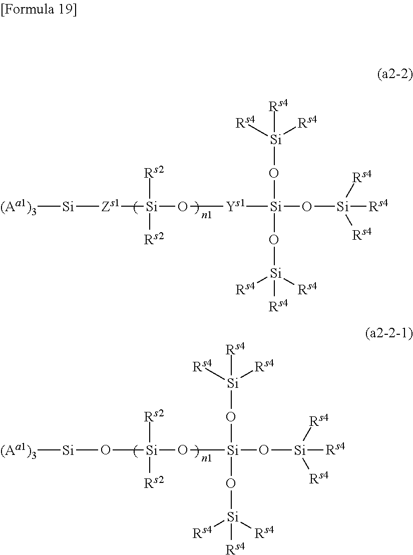

In formula (a2-2) and formula (a2-2-1), A^{a1}, Z^{s1}, R^{s2}, n1, Y^{s1} , and R^{s4} have the same meaning as described above.

Specific examples of the organosilicon compound (A) represented by formula (a2) include compounds represented by formula (A-I).

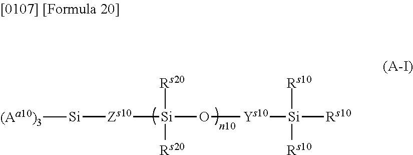

In formula (A-I) , A^{a10}, Z^{s10}, R^{s20}, n10, Y^{s10}, and R^{s10} are preferably combined as shown in Tables 3-1, 3-2, 4-1, and 4-2 below.

TABLE 3-1

| | A^{a10} | Z^{s10} | R^{s20} | n10 | Y^{s10} | R^{s10} |
|---|---|---|---|---|---|---|
| (A-I-1) | C₂H₅O—* | *—O—* | CH₃—* | 1~60 | — | (CH₃)₃SiO—* |
| (A-I-2) | C₂H₅O—* | *—O—* | CH₃—* | 1~60 | *—Si(CH₃)₂—CH₂—* | (CH₃)₃SiO—* |
| (A-I-3) | C₂H₅O—* | *—O—* | CH₃—* | 1~60 | *—Si(CH₃)₂—(CH₂)₂—* | (CH₃)₃SiO—* |
| (A-I-4) | C₂H₅O—* | *—O—* | CH₃—* | 1~60 | *—Si(CH₃)₂—(CH₂)₃—* | (CH₃)₃SiO—* |
| (A-I-5) | C₂H₅O—* | *—O—* | CH₃—* | 1~60 | *—Si(CH₃)₂—(CH₂)₄—* | (CH₃)₃SiO—* |
| (A-I-6) | C₂H₅O—* | *—CH₂—* | CH₃—* | 1~60 | — | (CH₃)₃SiO—* |
| (A-I-7) | C₂H₅O—* | *—CH₂—* | CH₃—* | 1~60 | *—Si(CH₃)₂—CH₂—* | (CH₃)₃SiO—* |
| (A-I-8) | C₂H₅O—* | *—CH₂—* | CH₃—* | 1~60 | *—Si(CH₃)₂—(CH₂)₂—* | (CH₃)₃SiO—* |
| (A-I-9) | C₂H₅O—* | *—CH₂—* | CH₃—* | 1~60 | *—Si(CH₃)₂—(CH₂)₃—* | (CH₃)₃SiO—* |
| (A-I-10) | C₂H₅O—* | *—CH₂—* | CH₃—* | 1~60 | *—Si(CH₃)₂—(CH₂)₄—* | (CH₃)₃SiO—* |
| (A-I-11) | C₂H₅O—* | *—(CH₂)₂—* | CH₃—* | 1~60 | — | (CH₃)₃SiO—* |
| (A-I-12) | C₂H₅O—* | *—(CH₂)₂—* | CH₃—* | 1~60 | *—Si(CH₃)₂—CH₂—* | (CH₃)₃SiO—* |
| (A-I-13) | C₂H₅O—* | *—(CH₂)₂—* | CH₃—* | 1~60 | *—Si(CH₃)₂—(CH₂)₂—* | (CH₃)₃SiO—* |
| (A-I-14) | C₂H₅O—* | *—(CH₂)₂—* | CH₃—* | 1~60 | *—Si(CH₃)₂—(CH₂)₃—* | (CH₃)₃SiO—* |
| (A-I-15) | C₂H₅O—* | *—(CH₂)₂—* | CH₃—* | 1~60 | *—Si(CH₃)₂—(CH₂)₄—* | (CH₃)₃SiO—* |
| (A-I-16) | C₂H₅O—* | *—(CH₂)₃—* | CH₃—* | 1~60 | — | (CH₃)₃SiO—* |
| (A-I-17) | C₂H₅O—* | *—(CH₂)₃—* | CH₃—* | 1~60 | *—Si(CH₃)₂—CH₂—* | (CH₃)₃SiO—* |
| (A-I-18) | C₂H₅O—* | *—(CH₂)₃—* | CH₃—* | 1~60 | *—Si(CH₃)₂—(CH₂)₂—* | (CH₃)₃SiO—* |
| (A-I-19) | C₂H₅O—* | *—(CH₂)₃—* | CH₃—* | 1~60 | *—Si(CH₃)₂—(CH₂)₃—* | (CH₃)₃SiO—* |
| (A-I-20) | C₂H₅O—* | *—(CH₂)₃—* | CH₃—* | 1~60 | *—Si(CH₃)₂—(CH₂)₄—* | (CH₃)₃SiO—* |
| (A-I-21) | C₂H₅O—* | *—(CH₂)₄—* | CH₃—* | 1~60 | — | (CH₃)₃SiO—* |
| (A-I-22) | C₂H₅O—* | *—(CH₂)₄—* | CH₃—* | 1~60 | *—Si(CH₃)₂—CH₂—* | (CH₃)₃SiO—* |
| (A-I-23) | C₂H₅O—* | *—(CH₂)₄—* | CH₃—* | 1~60 | *—Si(CH₃)₂—(CH₂)₂—* | (CH₃)₃SiO—* |
| (A-I-24) | C₂H₅O—* | *—(CH₂)₄—* | CH₃—* | 1~60 | *—Si(CH₃)₂—(CH₂)₃—* | (CH₃)₃SiO—* |
| (A-I-25) | C₂H₅O—* | *—(CH₂)₄—* | CH₃—* | 1~60 | *—Si(CH₃)₂—(CH₂)₄—* | (CH₃)₃SiO—* |

TABLE 3-2

| | A^{a10} | Z^{s10} | R^{s20} | n10 | Y^{s10} | R^{s10} |
|---|---|---|---|---|---|---|
| (A-I-26) | CH₃O—* | *—O—* | CH₃—* | 1~60 | — | (CH₃)₃SiO—* |
| (A-I-27) | CH₃O—* | *—O—* | CH₃—* | 1~60 | *—Si(CH₃)₂—CH₂—* | (CH₃)₃SiO—* |
| (A-I-28) | CH₃O—* | *—O—* | CH₃—* | 1~60 | *—Si(CH₃)₂—(CH₂)₂—* | (CH₃)₃SiO—* |
| (A-I-29) | CH₃O—* | *—O—* | CH₃—* | 1~60 | *—Si(CH₃)₂—(CH₂)₃—* | (CH₃)₃SiO—* |
| (A-I-30) | CH₃O—* | *—O—* | CH₃—* | 1~60 | *—Si(CH₃)₂—(CH₂)₄—* | (CH₃)₃SiO—* |
| (A-I-31) | CH₃O—* | *—CH₂—* | CH₃—* | 1~60 | — | (CH₃)₃SiO—* |
| (A-I-32) | CH₃O—* | *—CH₂—* | CH₃—* | 1~60 | *—Si(CH₃)₂—CH₂—* | (CH₃)₃SiO—* |
| (A-I-33) | CH₃O—* | *—CH₂—* | CH₃—* | 1~60 | *—Si(CH₃)₂—(CH₂)₂—* | (CH₃)₃SiO—* |
| (A-I-34) | CH₃O—* | *—CH₂—* | CH₃—* | 1~60 | *—Si(CH₃)₂—(CH₂)₃—* | (CH₃)₃SiO—* |
| (A-I-35) | CH₃O—* | *—CH₂—* | CH₃—* | 1~60 | *—Si(CH₃)₂—(CH₂)₄—* | (CH₃)₃SiO—* |
| (A-I-36) | CH₃O—* | *—(CH₂)₂—* | CH₃—* | 1~60 | — | (CH₃)₃SiO—* |
| (A-I-37) | CH₃O—* | *—(CH₂)₂—* | CH₃—* | 1~60 | *—Si(CH₃)₂—CH₂—* | (CH₃)₃SiO—* |
| (A-I-38) | CH₃O—* | *—(CH₂)₂—* | CH₃—* | 1~60 | *—Si(CH₃)₂—(CH₂)₂—* | (CH₃)₃SiO—* |
| (A-I-39) | CH₃O—* | *—(CH₂)₂—* | CH₃—* | 1~60 | *—Si(CH₃)₂—(CH₂)₃—* | (CH₃)₃SiO—* |
| (A-I-40) | CH₃O—* | *—(CH₂)₂—* | CH₃—* | 1~60 | *—Si(CH₃)₂—(CH₂)₄—* | (CH₃)₃SiO—* |
| (A-I-41) | CH₃O—* | *—(CH₂)₃—* | CH₃—* | 1~60 | — | (CH₃)₃SiO—* |
| (A-I-42) | CH₃O—* | *—(CH₂)₃—* | CH₃—* | 1~60 | *—Si(CH₃)₂—CH₂—* | (CH₃)₃SiO—* |
| (A-I-43) | CH₃O—* | *—(CH₂)₃—* | CH₃—* | 1~60 | *—Si(CH₃)₂—(CH₂)₂—* | (CH₃)₃SiO—* |
| (A-I-44) | CH₃O—* | *—(CH₂)₃—* | CH₃—* | 1~60 | *—Si(CH₃)₂—(CH₂)₃—* | (CH₃)₃SiO—* |
| (A-I-45) | CH₃O—* | *—(CH₂)₃—* | CH₃—* | 1~60 | *—Si(CH₃)₂—(CH₂)₄—* | (CH₃)₃SiO—* |
| (A-I-46) | CH₃O—* | *—(CH₂)₄—* | CH₃—* | 1~60 | — | (CH₃)₃SiO—* |
| (A-I-47) | CH₃O—* | *—(CH₂)₄—* | CH₃—* | 1~60 | *—Si(CH₃)₂—CH₂—* | (CH₃)₃SiO—* |
| (A-I-48) | CH₃O—* | *—(CH₂)₄—* | CH₃—* | 1~60 | *—Si(CH₃)₂—(CH₂)₂—* | (CH₃)₃SiO—* |
| (A-I-49) | CH₃O—* | *—(CH₂)₄—* | CH₃—* | 1~60 | *—Si(CH₃)₂—(CH₂)₃—* | (CH₃)₃SiO—* |
| (A-I-50) | CH₃O—* | *—(CH₂)₄—* | CH₃—* | 1~60 | *—Si(CH₃)₂—(CH₂)₄—* | (CH₃)₃SiO—* |

TABLE 4-1

| | A^{a10} | Z^{s10} | R^{s20} | n10 | Y^{s10} | R^{s10} |
|---|---|---|---|---|---|---|
| (A-I-51) | C₂H₅O—* | *—O—* | CH₃—* | 1~60 | — | CH₃—* |
| (A-I-52) | C₂H₅O—* | *—O—* | CH₃—* | 1~60 | *—Si(CH₃)₂—CH₂—* | CH₃—* |
| (A-I-53) | C₂H₅O—* | *—O—* | CH₃—* | 1~60 | *—Si(CH₃)₂—(CH₂)₂—* | CH₃—* |
| (A-I-54) | C₂H₅O—* | *—O—* | CH₃—* | 1~60 | *—Si(CH₃)₂—(CH₂)₃—* | CH₃—* |
| (A-I-55) | C₂H₅O—* | *—O—* | CH₃—* | 1~60 | *—Si(CH₃)₂—(CH₂)₄—* | CH₃—* |
| (A-I-56) | C₂H₅O—* | *—CH₂—* | CH₃—* | 1~60 | — | CH₃—* |
| (A-I-57) | C₂H₅O—* | *—CH₂—* | CH₃—* | 1~60 | *—Si(CH₃)₂—CH₂—* | CH₃—* |
| (A-I-58) | C₂H₅O—* | *—CH₂—* | CH₃—* | 1~60 | *—Si(CH₃)₂—(CH₂)₂—* | CH₃—* |
| (A-I-59) | C₂H₅O—* | *—CH₂—* | CH₃—* | 1~60 | *—Si(CH₃)₂—(CH₂)₃—* | CH₃—* |
| (A-I-60) | C₂H₅O—* | *—CH₂—* | CH₃—* | 1~60 | *—Si(CH₃).₂—(CH₂)₄—* | CH₃—* |
| (A-I-61) | C₂H₅O—* | *—(CH₂)₂—* | CH₃—* | 1~60 | — | CH₃—* |
| (A-I-62) | C₂H₅O—* | *—(CH₂)₂—* | CH₃—* | 1~60 | *—Si(CH₃)₂—CH₂—* | CH₃—* |
| (A-I-63) | C₂H₅O—* | *—(CH₂)₂—* | CH₃—* | 1~60 | *—Si(CH₃)₂—(CH₂)₂—* | CH₃—* |
| (A-I-64) | C₂H₅O—* | *—(CH₂)₂—* | CH₃—* | 1~60 | *—Si (CH₃)₂—(CH₂)₃—* | CH₃—* |
| (A-I-65) | C₂H₅O—* | *—(CH₂)₂—* | CH₃—* | 1~60 | *—Si(CH₃)₂—(CH₂)₄—* | CH₃—* |
| (A-I-66) | C₂H₅O—* | *—(CH₂)₃—* | CH₃—* | 1~60 | — | CH₃—* |
| (A-I-67) | C₂H₅O—* | *—(CH₂)₃—* | CH₃—* | 1~60 | *—Si(CH₃)₂—CH₂—* | CH₃—* |
| (A-I-68) | C₂H₅O—* | *—(CH₂)₃—* | CH₃—* | 1~60 | *—Si(CH₃)₂—(CH₂)₂—* | CH₃—* |
| (A-I-69) | C₂H₅O—* | *—(CH₂)₃—* | CH₃—* | 1~60 | *—Si(CH₃)₂—(CH₂)₃—* | CH₃—* |
| (A-I-70) | C₂H₅O—* | *—(CH₂)₃—* | CH₃—* | 1~60 | *—Si(CH₃)₂—(CH₂)₄—* | CH₃—* |
| (A-I-71) | C₂H₅O—* | *—(CH₂)₄—* | CH₃—* | 1~60 | — | CH₃—* |
| (A-I-72) | C₂H₅O—* | *—(CH₂)₄—* | CH₃—* | 1~60 | *—Si(CH₃)₂—CH₂—* | CH₃—* |
| (A-I-73) | C₂H₅O—* | *—(CH₂)₄—* | CH₃—* | 1~60 | *—Si(CH₃)₂—(CH₂)₂—* | CH₃—* |
| (A-I-74) | C₂H₅O—* | *—(CH₂)₄—* | CH₃—* | 1~60 | *—Si(CH₃)₂—(CH₂)₃—* | CH₃—* |
| (A-I-75) | C₂H₅O—* | *—(CH₂)₄—* | CH₃—* | 1~60 | *—Si(CH₃)₂—(CH₂)₄—* | CH₃—* |

TABLE 4-2

| | A^{a10} | Z^{s10} | R^{s20} | n10 | Y^{s10} | R^{s10} |
|---|---|---|---|---|---|---|
| (A-I-76) | CH₃O—* | *—O—* | CH₃—* | 1~60 | — | CH₃—* |
| (A-I-77) | CH₃O—* | *—O—* | CH₃—* | 1~60 | *—Si(CH₃)₂—CH₂—* | CH₃—* |
| (A-I-78) | CH₃O—* | *—O—* | CH₃—* | 1~60 | *—Si(CH₃)₂—(CH₂)₂—* | CH₃—* |
| (A-I-79) | CH₃O—* | *—O—* | CH₃—* | 1~60 | *—Si(CH₃)₂—(CH₂)₃—* | CH₃—* |
| (A-I-80) | CH₃O—* | *—O—* | CH₃—* | 1~60 | *—Si(CH₃)₂—(CH₂)₄—* | CH₃—* |
| (A-I-81) | CH₃O—* | *—CH₂—* | CH₃—* | 1~60 | — | CH₃—* |
| (A-I-82) | CH₃O—* | *—CH₂—* | CH₃—* | 1~60 | *—Si(CH₃)₂—CH₂—* | CH₃—* |
| (A-I-83) | CH₃O—* | *—CH₂—* | CH₃—* | 1~60 | *—Si(CH₃)₂—(CH₂)₂—* | CH₃—* |
| (A-I-84) | CH₃O—* | *—CH₂—* | CH₃—* | 1~60 | *—Si(CH₃)₂—(CH₂)₃—* | CH₃—* |
| (A-I-85) | CH₃O—* | *—CH₂—* | CH₃—* | 1~60 | *—Si(CH₃)₂—(CH₂)₄—* | CH₃—* |
| (A-I-86) | CH₃O—* | *—(CH₂)₂—* | CH₃—* | 1~60 | — | CH₃—* |
| (A-I-87) | CH₃O—* | *—(CH₂)₂—* | CH₃—* | 1~60 | *—Si(CH₃)₂—CH₂—* | CH₃—* |
| (A-I-88) | CH₃O—* | *—(CH₂)₂—* | CH₃—* | 1~60 | *—Si(CH₃)₂—(CH₂)₂—* | CH₃—* |
| (A-I-89) | CH₃O—* | *—(CH₂)₂—* | CH₃—* | 1~60 | *—Si(CH₃)₂—(CH₂)₃—* | CH₃—* |
| (A-I-90) | CH₃O—* | *—(CH₂)₂—* | CH₃—* | 1~60 | *—Si(CH₃)₂—(CH₂)₄—* | CH₃—* |
| (A-I-91) | CH₃O—* | *—(CH₂)₃—* | CH₃—* | 1~60 | — | CH₃—* |
| (A-I-92) | CH₃O—* | *—(CH₂)₃—* | CH₃—* | 1~60 | *—Si(CH₃)₂—CH₂—* | CH₃—* |
| (A-I-93) | CH₃O—* | *—(CH₂)₃—* | CH₃—* | 1~60 | *—Si(CH₃)₂—(CH₂)₂—* | CH₃—* |
| (A-I-94) | CH₃O—* | *—(CH₂)₃—* | CH₃—* | 1~60 | *—Si(CH₃)₂—(CH₂)₃—* | CH₃—* |
| (A-I-95) | CH₃O—* | *—(CH₂)₃—* | CH₃—* | 1~60 | *—Si(CH₃)—(CH₂)₄—* | CH₃—* |
| (A-I-96) | CH₃O—* | *—(CH₂)₄—* | CH₃—* | 1~60 | — | CH₃—* |
| (A-I-97) | CH₃O—* | *—(CH₂)₄—* | CH₃—* | 1~60 | *—Si(CH₃)₂—CH₂—* | CH₃—* |
| (A-I-98) | CH₃O—* | *—(CH₂)₄—* | CH₃—* | 1~60 | *—Si(CH₃)₂—(CH₂)₂—* | CH₃—* |
| (A-I-99) | CH₃O—* | *—(CH₂)₄—* | CH₃—* | 1~60 | *—Si(CH₃)₂—(CH₂)₃—* | CH₃—* |
| (A-I-100) | CH₃O—* | *—(CH₂)₄—* | CH₃—* | 1~60 | *—Si(CH₃)₂—(CH₂)₄—* | CH₃—* |

The n10 shown in Tables 3-1 and 3-2, 4-1 and 4-2 is preferably 1 to 30.

Among formulas (A-I), an organosilicon compound represented by (A-I-26) is more preferable. That is, as the organosilicon compound (A) represented by formula (a2), an organosilicon compound represented by the following formula (a3) is preferable.

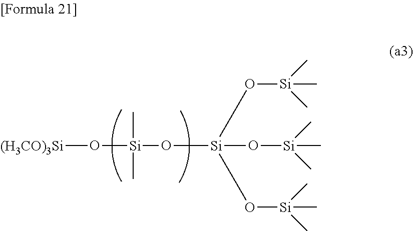

In formula (a3), n2 is an integer of 1 to 60.

More preferably, n2 is an integer of 2 or more, and further preferably an integer of 3 or more, and is more preferably an integer of 50 or less, further preferably an integer of 45 or less, still further preferably an integer of 30 or less, and particularly preferably an integer of 25 or less.

The amount of the organosilicon compound (A) is, based on the whole composition of 100% by mass, preferably 0.01% by mass or more, more preferably 0.015% by mass or more, and further preferably 0.02% by mass or more, and is preferably 0.5% by mass or less, more preferably 0.4% by mass or less, and further preferably 0.3% by mass or less.

The organosilicon compound (A) may include an oligomer. When the organosilicon compound (A) includes an oligomer, the number of moles may be calculated using the number average molecular weight.

The amount of the above-mentioned organosilicon compound (A) can be adjusted at the time of preparation of the composition. Further, the amount of the organosilicon compound (A) may be calculated from an analysis result of the composition. It is noted that in the present specification, when referring to the ranges of the amount, mass ratio, or molar ratio of each component, as described above, those ranges can be adjusted at the time of preparation of the composition.

Examples of the method for synthesizing the organosilicon compound (A) include the methods described in Japanese Patent Laid-Open No. 2017-201009.

### 2. Metal Compound (B)

The metal compound (B) according to the present invention is a compound that includes a metal, functions as a spacer when mixed with the organosilicon compound (A), and appropriately disperses the above-described trialkylsilyl group. As a result, it is considered that the water and oil repellency of the coating film can be improved.

The metal compound (B) preferably has at least one hydrolyzable group bonded to the metal atom.

The metal composition (B) is preferably a compound represented by the following formula (b1).

M(R^{b10})ᵣ(A^{b1})ₘ₋ᵣ (b1)

In formula (b1), M represents Al, Fe, In, Ge, Hf, Si, Ti, Sn, Zr, or Ta, R^{b10} represents a siloxane skeleton-containing group, a hydrocarbon chain-containing group, or a hydrogen atom, r is 0 or 1, a plurality of A^{b1} each independently represent a hydrolyzable group, and m, which is a valence of the metal atom M, denotes an integer selected from 3 to 5.

The compound represented by formula (b1) is a compound in which at least a hydrolyzable group A^{b1} is bonded to a metal atom M. In the present specification, the term “metal” is used in a sense that includes semimetals such as Si and Ge.

As described above, a coating film obtained from the composition of the present invention has higher water-repellency and oil-repellency functions due to the trialkylsilyl group derived from the organosilicon compound (A), and it is considered that the structure based on the metal compound (B) functions as a spacer in the coating film.

The metal atom M is preferably Al, Si, Ti, Sn, or Zr, more preferably Al, Si, Ti or Zr, and further preferably Si.

The siloxane skeleton-containing group may be a group having a siloxane skeleton-containing group in at least a portion thereof, and the hydrocarbon chain-containing group may be a group having a hydrocarbon chain in at least a portion thereof.

When the metal atom M is Si, the siloxane skeleton-containing group of R^{b10} is preferably a group that does not contain a dialkylsiloxane chain.

The hydrolyzable group represented by A^{b1} and the siloxane skeleton-containing group or hydrocarbon chain-containing group represented by R^{b10} can be appropriately selected from the hydrolyzable groups, siloxane skeleton-containing groups, and hydrocarbon chain-containing groups described for the organosilicon compound (A), and the preferred ranges thereof are also the same.

Here, “m” is the valence of the metal atom M so when the metal atom M is a trivalent metal such as Al, Fe, or In, m is 3, when the metal atom M is a tetravalent metal such as Ge, Hf, Si, Ti, Sn, or Zr, m is 4, and when the metal atom M is a pentavalent metal such as Ta, m is 5.

In the composition of the present invention, two or more types of the metal compound (B) may be mixed.

Examples of the metal compound (B) include: a metal compound B1 in which r=0, that is, only a hydrolyzable group A¹ is bonded to the metal atom M; and a metal compound B² in which r=1, that is, one siloxane skeleton-containing group, hydrocarbon chain-containing group, or hydrogen atom and two or more hydrolyzable groups A^{b1} are bonded to the metal atom M.

### (Metal Compound B1)

Specific examples of the metal compound B1 in which only a hydrolyzable group A^{b1} is bonded to the metal atom M include: trialkoxyaluminum, such as triethoxyaluminum, tripropoxyaluminum, and tributoxyaluminum; trialkoxyiron, such as triethoxyiron; trialkoxyindium, such as trimethoxyindium, triethoxyindium, tripropoxyindium, and tributoxyindium; tetraalkoxygermanium, such as tetramethoxygermanium, tetraethoxygermanium, tetrapropoxygermanium, and tetrabutoxygermanium; tetraalkoxyhafnium, such as tetramethoxyhafnium, tetraethoxyhafnium, tetrapropoxyhafnium, and tetrabutoxyhafnium; tetraalkoxysilane, such as tetramethoxysilane, tetraethoxysilane, tetrapropoxysilane, and tetrabutoxysilane; tetraalkoxytitanium, such as tetramethoxytitanium, tetraethoxytitanium, tetrapropoxytitanium, and tetrabutoxytitanium; tetraalkoxytin, such as tetramethoxytin, tetraethoxytin, tetrapropoxytin, and tetrabutoxytin; tetraalkoxyzirconium, such as tetramethoxyzirconium, tetraethoxyzirconium, tetrapropoxyzirconium, and tetrabutoxyzirconium; penta-alkoxytantalums such as pentamethoxytantalum, pentaethoxytantalum, pentapropoxytantalum, pentabutoxytantalum; and the like.

### (Metal Compound B2)

The metal compound B2, in which one siloxane skeleton-containing group, hydrocarbon chain-containing group, or hydrogen atom and two or more hydrolyzable groups A^{b1} are bonded to the metal atom M, is preferably a metal compound in which the metal atom M is a tetravalent metal (Ge, Hf, Si, Ti, Sn, Zr, etc.). Specific examples when the metal atom M is Si include: trimethylsilyloxytrialkoxysilanes, such as trimethylsilyloxytrimethoxysilane, trimethylsilyloxytriethoxysilane, and trimethylsilyloxytripropoxysilane; alkyltrialkoxysilanes, such as methyltrimethoxysilane, ethyltrimethoxysilane, methyltriethoxysilane, ethyltriethoxysilane, and methyltripropoxysilane; alkenyltrialkoxysilanes, such as vinyltrimethoxysilane and vinyltriethoxysilane; trialkoxysilanes, such as trimethoxysilane, triethoxysilane and tripropoxysilane; dialkoxyalkylsilanes such as dimethoxymethylsilane and diethoxymethylsilane; and the like.

Specifically, as the metal compound (B), a compound represented by the following formula (b2) is preferable.

Si(OR^{b22})_{y}H_{4-y} (b2)

In formula (b2), R^{b11} represents an alkyl group having 1 to 6 carbon atoms, and y is 3 or 4.

Examples of the alkyl group represented by R^{b22} include a methyl group, an ethyl group, a propyl group, a butyl group, a pentyl group, a hexyl group, and the like.

The number of carbon atoms of the alkyl group represented by R^{b11} is preferably 1 to 4, more preferably 1 to 3, and further preferably 1 or 2.

The amount of the metal compound (B) is, based on the whole composition of 100% by mass, preferably 0.01% by mass or more, more preferably 0.03% by mass or more, and further preferably 0.05% by mass or more, and is preferably 5% by mass or less, more preferably 2% by mass or less, and further preferably 1% by mass or less.

The total amount (A+B) of the organosilicon compound (A) and the metal compound (B) is, based on the whole composition of 100% by mass, preferably 0.01% by mass or more, more preferably 0.05% by mass or more, and further preferably 0.08% by mass or more, and is preferably 5% by mass or less, more preferably 3% by mass or less, further preferably 2% by mass or less, and particularly preferably 1.5% by mass or less.

The molar ratio (B/A) of the metal compound (B) to the organosilicon compound (A) is preferably 2 to 500. The molar ratio (B/A) is more preferably 8 or more, further preferably 10 or more, particularly preferably 15 or more, and most preferably 20 or more, and is more preferably 200 or less, further preferably 100 or less, and particularly preferably 50 or less.

### 3. Acid (C)

The acid (C) may be an inorganic acid or an organic acid. Specific examples include nitric acid, hydrochloric acid, maleic acid, phosphoric acid, malonic acid, formic acid, benzoic acid, phenylethane acid, acetic acid, butanoic acid, 2-methylpropanoic acid, propanoic acid, 2,2-dimethylpropanoic acid, and the like.

Only one type of the acid (C) may be included, or a combination of two or more types of the acid (C) may be included. As the acid (C), an organic acid is preferable, and maleic acid, malonic acid, and acetic acid are more preferable.

The amount of the acid (C) is, based on the whole composition of 100% by mass, preferably 30% by mass or less, more preferably 10% by mass or less, further preferably 1% by mass or less, and particularly preferably 0.5% by mass or less. The lower limit of the amount of the acid (C) is, based on the whole composition of 100% by mass, more than 0% by mass, preferably 0.00001% by mass or more, and more preferably 0.0001% by mass or more.

The acid (C) has a pKa at the time of the first dissociation of preferably 1 or more, so that the reaction when forming the coating film can be made to proceed in a moderate manner, and a good coating film can be formed. The pKa is the acid dissociation constant. The pKa of the acid (C) at the time of the first dissociation is preferably 1.5 or more, more preferably 2.5 or more, and further preferably 3.5 or more. The upper limit of the pKa at the time of the first dissociation of the acid (C) is not particularly limited, and is, for example, preferably 10 or less, more preferably 8 or less, and further preferably 6 or less.

When an acid having a pKa at the time of the first dissociation of 1 or more is used as the acid (C), an acid having a pKa at the time of the first dissociation of less than 1 may or may not be used in combination therewith. In the case of using an acid having a pKa at the time of the first dissociation of less than 1, based on the whole composition of 100% by mass, the amount of the acid having a pKa at the time of the first dissociation of less than 1 is preferably less than 2.0% by mass, more preferably 1.5% by mass or less, further preferably 1% by mass or less, still further preferably 0.5% by mass or less, and particularly preferably 0.1% by mass or less.

Specifically, the pKa of the acid (C) is maleic acid pKa=1.92, phosphoric acid pKa=2.12, malonic acid pKa=2.60, formic acid pKa=3.75, benzoic acid pKa=4.2, phenylethanoic acid pKa=4.31, acetic acid pKa=4.76, butanoic acid pKa=4.83, 2-methylpropanoic acid pKa=4.84, propanoic acid pKa=4.87, 2,2-dimethylpropanoic acid pKa=5.03, nitric acid pKa=−1.5, and hydrochloric acid pKa=−8.

### 4. Water (D)

In the present invention, a ratio [D/(A+B)] of a molar amount of the water (D) to a total molar amount of the organosilicon compound (A) and the metal compound (B) is 3.1 to 130. By controlling this ratio [D/(A+B)], water repellency and oil repellency as well as wear resistance can be achieved.

The ratio [D/(A+B)] of the molar amount of the water (D) to the total molar amount of the organosilicon compound (A) and the metal compound (B) in the mixed composition is preferably 3.15 or more, preferably 10 or more, and more preferably 20 or more, and is preferably 127 or less, more preferably 100 or less, further preferably 90 or less, and particularly preferably 80 or less.

The amount of the water (D) is, based on the whole composition of 100% by mass, preferably 0.01 to 2.0% by mass. By setting the amount of water to 2.0% by mass or less, the reaction when forming the coating film can be made to proceed in a moderate manner, and a good coating film can be formed. By setting the amount of the water to 2.0% by mass or less, the reaction at the time of forming the coating film can be made to proceed in a moderate manner, and a good coating film can be formed. The amount of the water (D) is, based on the whole composition of 100% by mass, preferably 1.5% by mass or less, more preferably 1.3% by mass or less, and further preferably 1.0% by mass or less, and is preferably 0.01% by mass or more, more preferably 0.015% by mass or more, and further preferably 0.02% by mass or more.

The mixed composition of the present invention is a composition in which the above-described organosilicon compound (A), metal compound (B), acid (C), and water (D) are mixed, and can be obtained by mixing those components (A) to (D).

### 5. Solvent (E)

A solvent (E) may be used in the composition of the present invention. The solvent (E) means a solvent other than water, and examples thereof include alcohol solvents, ether solvents, ketone solvents, ester solvents, amide solvents, and the like. Examples of the alcohol solvent include methanol, ethanol, propanol, 2-propanol (isopropyl alcohol), butanol, ethylene glycol, propylene glycol, diethylene glycol, and the like. Examples of the ether solvent include dimethoxyethane, tetrahydrofuran, dioxane, and the like. Examples of the ketone solvent include acetone, methyl ethyl ketone (2-butanone), and the like. Examples of the ester solvent include ethyl acetate, butyl acetate, and the like. Examples of the amide solvent include dimethylformamide and the like. Among these, an alcohol solvent or an ether solvent is preferable, and an alcohol solvent is more preferable.

The amount of the solvent (E) is, based on the whole composition of 100% by mass, preferably 10% by mass or more, more preferably 50% by mass or more, further preferably 90% by mass or more, and particularly preferably 95% by mass or more, and is preferably 99.95% by mass or less, more preferably 99.90% by mass or less, and further preferably 99.88% by mass or less.

The composition of the present invention may coexist with, within a range that does not harm the effect of the present invention, for example, various additives such as an antioxidant, a rust preventive, an ultraviolet absorber, a light stabilizer, a fungicide, an antibacterial agent, a biofouling inhibitor, a deodorant, a pigment, a flame retardant, and an antistatic agent.

By curing the composition of the present invention, a film is obtained. The cured film acts as a liquid-repellent layer, which has excellent water and oil repellency and wear resistance.

The film obtained by curing the composition of the present invention may be formed on a substrate.

Examples of the method of bringing the composition of the present invention (hereinafter, sometimes referred to as “composition for forming a liquid-repellent layer”) into contact with the base material include a method of coating the composition onto the base material. Specifically, a spin coating method, a dip coating method, a spray coating method, a roll coating method, a bar coating method, applying by hand (method in which a liquid is impregnated into a cloth and applied onto the base material), pouring (method in which a liquid is applied as is onto the base material using a dropper or the like), a spraying method (method in which a spray is used to apply onto the base material), and the like. In particular, from the viewpoint of workability, a spin coating method, a spray coating method, applying by hand, pouring, and spraying are preferable, spin coating, applying by hand, or spraying is more preferable, and spin coating is further preferable.

The coating film can be formed on the base material by, in a state in which the composition for forming a liquid-repellent layer of the present invention is in contact with the base material, leaving the composition to stand in air at normal temperature (for example, 10 minutes to 48 hours), or heating (for example, at 300° C. or less, and particularly 80 to 300° C.) the composition for about 1 to 10 hours, to promote hydrolysis of the hydrolyzable group and polycondensation.

The film thickness of the coating film can be, for example, about 0.5 to 100 nm.

The base material that the composition for forming a liquid-repellent layer of the present invention is brought into contact with is not particularly limited, and the shape of the base material may be a flat surface, a curved surface, or a three-dimensional structure in which a number of surfaces are combined.

The material of the base material is also not limited, and may be composed of either an organic material or an inorganic material. Examples of organic materials include thermoplastic resins such as acrylic resin, polycarbonate resin, polyester resin, styrene resin, acrylic-styrene copolymer resin, cellulose resin, and polyolefin resin; thermosetting resins such as phenol resin, urea resin, melamine resin, epoxy resin, unsaturated polyester, silicone resin, and urethane resin; and the like. Examples of inorganic materials include ceramics; glass; metals such as iron, silicon, copper, zinc, and aluminum; alloys that include the above metals; and the like.

The base material may be subjected to an easy-adhesion treatment in advance. Examples of the easy-adhesion treatment include hydrophilic treatments such as a corona treatment, a plasma treatment, and an ultraviolet treatment. Further, the base material may also be subjected to a primer treatment with a resin, a silane coupling agent, tetraalkoxysilane, or the like, or a glass coating film of polysilazane or the like may be applied to the base material in advance.

It is preferable to further form an intermediate layer between the coating film obtained from the composition for forming a liquid-repellent layer of the present invention and the above-described base material. That is, it is preferable to form on the base material an intermediate layer obtained from a composition for forming an intermediate layer, and to then form on the surface of this intermediate layer (the surface opposite to the base material) the liquid-repellent layer obtained from the composition for forming a liquid-repellent layer.

Examples of the composition for forming an intermediate layer include a mixed composition containing a polysilazane (F), in which at least one metal compound (G) selected from a metal compound represented by the following formula (g1) and a condensate thereof and/or a compound (H) including a siloxane chain are mixed. By forming an intermediate layer obtained from such a composition for forming an intermediate layer between the liquid-repellent layer and the base material, compared with a case where only the liquid-repellent layer is formed on the base material, the formation reaction of the liquid-repellent layer is promoted, the crosslinking density of liquid-repellent layer is increased, and the wear resistance of liquid-repellent layer is significantly improved. In addition, conventionally, heating was required when forming the liquid-repellent layer at a practical speed, but by forming an intermediate layer between the liquid-repellent layer and the base material, room temperature curing of liquid-repellent layer at a practical speed is easy.

M(R^{g10})ᵣ(A^{g1})ₘ₋ᵣ (g1)

In formula (g1), M represents Al, Fe, In, Ge, Hf, Si, Ti, Sn, Zr, or Ta. R^{g10} represents a hydrocarbon chain-containing group or a hydrogen atom, and r is 0 or 1. A plurality of A^{g1} each independently represent a hydrolyzable group, and m, which is the valence of the metal atom M, denotes an integer selected from 3 to 5.

The composition for forming an intermediate layer is now described.

### 11. Polysilazane (F)

The composition for forming an intermediate layer contains at least a polysilazane (F). The polysilazane (F) is not particularly limited as long as it is a compound having a silicon-nitrogen bond, but preferably it has a structural unit represented by the following formula (f1).

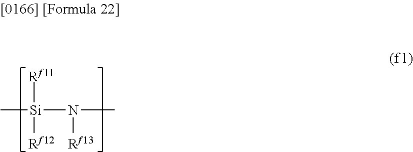

In formula (f1), R^{f11}, R^{f12}, and R^{f13} each independently represent a hydrogen atom, an optionally-substituted hydrocarbon group having 1 to 10 carbon atoms, or an alkylsilyl group.

Examples of the hydrocarbon group having 1 to 10 carbon atoms represented by R^{f11} to R^{f13} include straight saturated aliphatic hydrocarbon groups such as a methyl group, an ethyl group, a propyl group, a butyl group, a pentyl group, a hexyl group, a heptyl group, an octyl group, a nonyl group, and a decyl group; branched saturated aliphatic hydrocarbon groups such as an isopropyl group, a sec-butyl group, a tert-butyl group, a methylpentyl group, an ethylpentyl group, a methylhexyl group, an ethylhexyl group, a propyl hexyl group, and a tert-octyl group; cyclic saturated aliphatic hydrocarbon groups such as a cyclopentyl group, a cyclohexyl group, a cycloheptyl group, and a cyclo-octyl group; unsaturated aliphatic hydrocarbon groups such as a vinyl group, a 1-propenyl group, a 2-propenyl group, a 1-butenyl group, a 2-butenyl group, and a 3-butenyl group; aromatic hydrocarbon groups such as a phenyl group, a naphthyl group, a p-tert-butylphenyl group, a tolyl group, a xylyl group, a cumenyl group, a mesityl group, a 2,6-diethylphenyl group, and a 2-methyl-6-ethylphenyl group; and groups combining of the hydrocarbon groups mentioned here, such as an alkylcycloalkyl group, a cycloalkylalkyl group, and an aralkyl group.

Examples of the substituent that the hydrocarbon group having 1 to 10 carbon atoms optionally has include: a halogen atom selected from a fluorine atom, a chlorine atom, a bromine atom, and an iodine atom; a hydroxy group; a nitro group; an amino group; a cyano group; a thiol group; an epoxy group; a glycidoxy group; a (meth)acroyloxy group; a heteroaryl group having 6 to 12 atoms forming a ring; an alkoxy group having 1 to 3 carbon atoms, such as a methoxy group and an ethoxy group; an aryloxy group having 6 to 12 carbon atoms forming a ring; and the like.

The hydrocarbon group having 1 to 10 carbon atoms represented by R^{f11} to R^{f13} is preferably an unsubstituted saturated aliphatic hydrocarbon group having 1 to 10 carbon atoms, more preferably an unsubstituted saturated aliphatic hydrocarbon group having 1 to 6 carbon atoms, and further preferably an unsubstituted methyl group, ethyl group, propyl group, or butyl group, and most preferably a methyl group.

Examples of the alkylsilyl group represented by R^{f11} to R^{f13} include a trimethylsilyl group, a triethylsilyl group, a tri-n-propylsilyl group, a tri-isopropylsilyl group, a tri-t-butylsilyl group, a methyldiethylsilyl group, a dimethylsilyl group, a diethylsilyl group, a methylsilyl group, an ethylsilyl group, and the like.

The polysilazane (F) is preferably an organic polysilazane having a structural unit (f2) in which at least one of R^{f11} and R^{f12} in formula (f1) is a hydrocarbon group having 1 to 10 carbon atoms. Further, R^{f13} is preferably a hydrogen atom.

It is more preferable that, in addition to the structural unit (f2), the polysilazane (F) additionally has a structural unit represented by the following formula (f3).

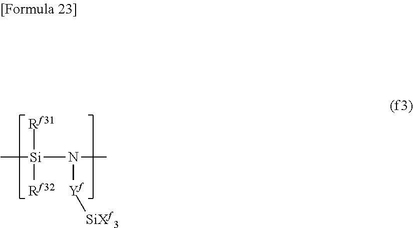

In formula (f3), R^{f31} and R^{f32} each independently represent a hydrogen atom or a hydrocarbon group having 1 to 10 carbon atoms, Y^{f} represents a divalent hydrocarbon group having 1 to 10 carbon atoms, and a plurality of X^{f} each independently represent a hydrolyzable group.

Examples of the hydrocarbon group having 1 to 10 carbon atoms represented by R^{f31} and R^{f32} include the same groups as those described for the hydrocarbon group having 1 to 10 carbon atoms represented by R^{f11} to R^{f13}. Among them, a saturated aliphatic hydrocarbon group having 1 to 10 carbon atoms is preferable, more preferable is a straight saturated aliphatic hydrocarbon group having 1 to 6 carbon atoms, and further preferable is a methyl group, an ethyl group, a propyl group, or a butyl group.

The number of carbon atoms of the divalent hydrocarbon group represented by Y^{f} is preferably 1 to 4, more preferably 1 to 3, and further preferably 1 to 2. The divalent hydrocarbon group is preferably in the form of a chain, and when it is in the form of a chain, the divalent hydrocarbon group may be in the form of straight or branched chain. The divalent hydrocarbon group is preferably a divalent aliphatic hydrocarbon group, and preferably an alkanediyl group. Examples of the divalent hydrocarbon group include a methylene group, an ethylene group, a propylene group, a butylene group, and the like.

Further, some of the —CH₂— included in the divalent hydrocarbon group may be replaced by —O—. In this case, two consecutive —CH₂— are not replaced by —O— at the same time, and a —CH₂— adjacent to the Si atom is not replaced by —O—. When two or more —CH₂— are replaced by —O—, the number of carbon atoms between —O— and —O— is preferably 2 to 4, and more preferably 2 to 3. Specific examples of the group in which some of the divalent hydrocarbon groups are replaced by —O— include a group having a (poly)ethylene glycol unit, a group having a (poly)propylene glycol unit, and the like.

The hydrolyzable group represented by X^{f} may be any group that gives a hydroxy group (silanol group) by hydrolysis. Preferable examples thereof include an alkoxy group having 1 to 4 carbon atoms, such as a methoxy group, an ethoxy group, a propoxy group, and a butoxy group; a hydroxy group; an acetoxy group; a chlorine atom; an isocyanate group; and the like. Among these, an alkoxy group having 1 to 4 carbon atoms is preferable, and an alkoxy group having 1 to 2 carbon atoms is more preferable. The plurality of X^{f}s may be the same or different, but are preferably the same.

The content of the SiX^{f}₃ group of formula (f3) is, based on 100% by mass of the polysilazane (F), preferably 2% by mass or more, more preferably 5% by mass or more, and further preferably 8% by mass or more. The upper limit is not limited, but it may be 50% by mass or less, 40% by mass or less, or 30% by mass or less.

When the polysilazane (F) is an organic polysilazane, the content ratio of the hydrogen atom of Si-H and the hydrocarbon group having 1 to 10 carbon atoms bonded to the Si can be appropriately selected. For example, the molar ratio of the hydrocarbon group/hydrogen atom is 0.1 to 50, and preferably 0.2 to 10. The molar ratio can be calculated from NMR measurement and the like.

The amount of the polysilazane (F) is, based on the whole composition of 100% by mass, preferably 0.01% by mass or more, more preferably 0.05% by mass or more, further preferably 0.1% by mass or more, and still further preferably 0.3% by mass or more, and is preferably 2.5% by mass or less, more preferably 2% by mass or less, further preferably 1.5% by mass or less, and still further preferably 1% by mass or less.

12. Metal compound (G)

In the composition for forming an intermediate layer, at least one metal compound (G) selected from a metal compound represented by the following formula (g1) and a condensate thereof may be used.

M(R^{g10})ᵣ(A^{g1})ₘ₋ᵣ (g1)

In formula (g1), M represents Al, Fe, In, Ge, Hf, Si, Ti, Sn, Zr, or Ta. R^{g10} represents a hydrocarbon chain-containing group or a hydrogen atom, and r is 0 or 1. A plurality of A^{g1} each independently represent a hydrolyzable group, and m, which is the valence of the metal atom M, denotes an integer selected from 3 to 5.

The metal compound (G) is a compound in which, as represented by formula (g1), at least a hydrolyzable group A^{g1} is bonded to a metal atom M. In this specification, the meaning of “metal” includes semimetals such as Si and Ge.

The metal atom M is preferably Al, Si, Ti, Sn, or Zr, more preferably Al, Si, Ti, or Zr, and further preferably Si.

The hydrolyzable group represented by A^{g1} and the hydrocarbon chain-containing group represented by R^{g10} can be appropriately selected from the hydrolyzable groups and the hydrocarbon chain-containing groups described for the organosilicon compound (A), and the preferred ranges thereof are also the same.

Here, “m” is the valence of the metal atom M so when the metal atom M is a trivalent metal such as Al, Fe, or In, m is 3, when the metal atom M is a tetravalent metal such as Ge, Hf, Si, Ti, Sn, or Zr, m is 4, and when the metal atom M is a pentavalent metal such as Ta, m is 5.

The composition for forming an intermediate layer may include two or more types of the metal compound represented by formula (g1) and condensates thereof.

Examples of the metal compound (G) include: a metal compound G1 in which r=0, that is, only a hydrolyzable group A^{g1} is bonded to the metal atom M; and a metal compound G2 in which r=1, that is, one hydrocarbon chain-containing group or hydrogen atom and two or more hydrolyzable groups A^{g1} are bonded to the metal atom M.

### (Metal Compound G1)

Specific examples of the metal compound G1 in which only a hydrolyzable group A^{g1} is bonded to the metal atom M include: trialkoxyaluminum, such as triethoxyaluminum, tripropoxyaluminum, and tributoxyaluminum; trialkoxyiron, such as triethoxyiron; trialkoxyindium, such as trimethoxyindium, triethoxyindium, tripropoxyindium, and tributoxyindium; tetraalkoxygermanium, such as tetramethoxygermanium, tetraethoxygermanium, tetrapropoxygermanium, and tetrabutoxygermanium; tetraalkoxyhafnium, such as tetramethoxyhafnium, tetraethoxyhafnium, tetrapropoxyhafnium, and tetrabutoxyhafnium; tetraalkoxysilanes, such as tetramethoxysilane, tetraethoxysilane, tetrapropoxysilane, and tetrabutoxysilane; tetraalkoxytitanium, such as tetramethoxytitanium, tetraethoxytitanium, tetrapropoxytitanium, and tetrabutoxytitanium; tetraalkoxytin, such as tetramethoxytin, tetraethoxytin, tetrapropoxytin, and tetrabutoxytin; tetraalkoxyzirconium, such as tetramethoxyzirconium, tetraethoxyzirconium, tetrapropoxyzirconium, and tetrabutoxyzirconium; penta-alkoxytantalum such as pentamethoxytantalum, pentaethoxytantalum, pentapropoxytantalum, pentabutoxytantalum; and the like.

(Metal compound G2)

The metal compound G2, in which one hydrocarbon chain-containing group or hydrogen atom and two or more hydrolyzable groups A^{g1} are bonded to the metal atom M, is preferably a metal compound in which the metal atom M is a tetravalent metal (Ge, Hf, Si, Ti, Sn, Zr, etc.). Specific examples when the metal atom M is Si include: alkyltrialkoxysilanes, such as methyltrimethoxysilane, ethyltrimethoxysilane, methyltriethoxysilane, ethyltriethoxysilane, and methyltripropoxysilane; alkenyltrialkoxysilanes, such as vinyltrimethoxysilane and vinyltriethoxysilane; trialkoxysilanes, such as trimethoxysilane, triethoxysilane and tripropoxysilane; dialkoxyalkylsilanes such as dimethoxymethylsilane and diethoxymethylsilane; and the like.

Specifically, as the metal compound (G), at least one selected from a compound represented by the following formula (g2) and a condensate thereof is preferable.

Si(OR^{g21})_{z}(R^{g22})_{4-z} (g2)

In formula (g2), R^{g21} represents an alkyl group having 1 to 6 carbon atoms, R^{g22} represents a hydrocarbon chain-containing group or a hydrogen atom, and z is 3 or 4.

Examples of the alkyl group represented by R^{g21} include a methyl group, an ethyl group, a propyl group, a butyl group, a pentyl group, a hexyl group, and the like. The number of carbon atoms of the alkyl group represented by R^{g21} is preferably 1 to 4, more preferably 1 to 3, and further preferably 1 or 2.

Examples of the hydrocarbon chain-containing group represented by R^{g22} include the same groups as those described for the hydrocarbon chain-containing group represented by R^{g10}, and the preferred range is also the same.

Examples of condensates of the metal compound represented by formula (g1) include compounds formed by, for example, hydrolyzing and condensing the hydrolyzable groups of a plurality of metal compounds represented by formula (g1). The plurality of metal compounds represented by formula (g1) may be the same or different. The metal compound represented by formula (g1) is preferably a condensate of 2 to 60 metal compounds, more preferably a condensate of 2 to 40 metal compounds, further preferably a condensate of 2 to 20 metal compounds, and particularly preferably a condensate of 2 to 10 metal compounds. The metal compound represented by formula (g1) may be hydrolyzed and condensed to obtain a condensate, or a commercially available siloxane oligomer or resin may be used as appropriate.

The metal compound (G) is preferably at least one selected from a compound represented by formula (g2) and a condensate thereof.

The condensate of the compound represented by formula (g2) is preferably a compound formed by a hydrolyzing and condensing the (OR^{g21}) groups of a plurality of metal compounds represented by formula (g2). The plurality of metal compounds represented by formula (g2) may be the same or different. The condensate of the compound represented by formula (g2) is preferably a condensate of 2 to 60 of the metal compounds represented by formula (g2), more preferably a condensate of 2 to 40 of the metal compounds, further preferably a condensate of 2 to 20 of the metal compounds, and particularly preferably a condensate of 2 to 10 of the metal compounds.

Further, two or more types of the metal compound (G) may be used.

When the metal compound (G) is used in the composition for forming an intermediate layer, the amount of the metal compound (G) is, for example, based on the whole composition for forming an intermediate layer of 100% by mass, preferably 0.01% by mass or more, more preferably 0.05% by mass or more, and further preferably 0.1% by mass or more, and is preferably 10% by mass or less, more preferably 3% by mass or less, and further preferably 1% by mass or less.

When the metal compound (G) is used in the composition for forming an intermediate layer, the total amount of the polysilazane (F) and the metal compound (G) is, based on the whole composition for forming an intermediate layer of 100% by mass, for example, preferably 0.02% by mass or more, and more preferably 0.1% by mass or more, and is preferably 10% by mass or less, more preferably 5% by mass or less, and further preferably 3% by mass or less.

### 13. Compound (H) Including a Siloxane Chain

A compound (H) including a siloxane chain may be used in the composition for forming an intermediate layer.

The compound (H) including a siloxane chain is not particularly limited as long as it is a compound having at least one siloxane bond. The siloxane chain may be straight or branched, but is preferably straight.

The siloxane chain preferably includes a dialkylsiloxane chain, and more preferably a straight dialkylsiloxane chain. Further, the siloxane chain may further contain a divalent group other than the siloxane bond. Examples of the divalent group include a divalent hydrocarbon group, a group in which some of the methylene groups (—CH₂—) of the divalent hydrocarbon group are replaced by oxygen atoms, —O—, and the like.

It is preferable that a silyl group is bonded to the end of the siloxane chain. A silyl group is a group in which three substituents are bonded to a silicon atom. Examples of the substituents include a hydrogen atom, a hydrocarbon chain-containing group, an alkylsilyloxy group, a group including an alkylsilyl group and a siloxane chain, a hydrolyzable group, and the like.

The term hydrocarbon chain-containing group means a group having a hydrocarbon group in at least a portion thereof. Usually, the hydrocarbon chain-containing group is composed of only hydrocarbon groups (hydrocarbon chains), but if necessary, the hydrocarbon chain-containing group may be a group in which some of the methylene groups (—CH₂—) of the hydrocarbon chain are replaced by oxygen atoms. Further, a methylene group (—CH₂—) adjacent to the Si atom is not replaced by an oxygen atom, and two consecutive methylene groups (—CH₂—) are not replaced by oxygen atoms at the same time. The number of carbon atoms of the hydrocarbon chain moiety means, for a non-oxygen-substituted hydrocarbon chain-containing group, the number of carbon atoms constituting the hydrocarbon group (hydrocarbon chain), and for an oxygen-substituted hydrocarbon chain-containing group, the number of carbon atoms constituting the hydrocarbon group (hydrocarbon chain) counted by assuming that the oxygen atoms are a methylene group (—CH₂—). Hereinafter, unless otherwise specified, the hydrocarbon chain-containing group is described based on the example of a non-oxygen-substituted hydrocarbon chain-containing group (that is, a monovalent hydrocarbon group) as an example, but in the entire description below, it is possible to replace some of the methylene groups —CH₂— by oxygen atoms.

When the hydrocarbon chain-containing group is a hydrocarbon group, the hydrocarbon chain-containing group preferably has 1 or more and 3 or less carbon atoms, and more preferably 1 carbon atom. Further, the hydrocarbon chain-containing group may be a branched chain or a straight chain. The hydrocarbon chain-containing group is preferably a saturated or unsaturated aliphatic hydrocarbon chain-containing group, and more preferably a saturated aliphatic hydrocarbon chain-containing group. As the saturated aliphatic hydrocarbon chain-containing group, a saturated aliphatic hydrocarbon group (alkyl group) is more preferable. Examples of the saturated aliphatic hydrocarbon group include a methyl group, an ethyl group, a propyl group, and the like.

When some of the methylene groups (—CH₂—) of the saturated aliphatic hydrocarbon group are replaced by oxygen atoms, specific examples include a group having a (poly)ethylene glycol unit.

The hydrolyzable group may be any group that gives a hydroxy group (silanol group) by hydrolysis. Preferable examples thereof include an alkoxy group having 1 to 6 carbon atoms, such as a methoxy group, an ethoxy group, a propoxy group, and a butoxy group; a hydroxy group; an acetoxy group; a chlorine atom; an isocyanate group; and the like. Among these, an alkoxy group having 1 to 6 carbon atoms is preferable, an alkoxy group having 1 to 4 carbon atoms is more preferable, and an alkoxy group having 1 or 2 carbon atoms is further preferable.

When one silicon atom has a plurality of substituents, the plurality of substituents may be the same or different.

It is preferable that at least one end of the siloxane chain is bonded to a silicon atom to which at least one hydrolyzable group is bonded, more preferably to a silicon atom to which two or more hydrolyzable groups are bonded, and further preferably to a silicon atom to which three hydrolyzable groups are bonded. The silicon atom to which the hydrolyzable group(s) is/are bonded may be bonded to one end of the siloxane chain or to both ends of the siloxane chain, but is preferably bonded only to one end.

It is more preferable that both ends of the siloxane chain are bonded to any one of a silyl group having three alkoxy groups as substituents (trialkoxysilyl group), a silyl group having three alkyl groups as substituents (trialkylsilyl group), and a silyl group having three trialkylsilyloxy groups as substituents [tris(trialkylsilyloxy)silyl group]. It is particularly preferable that one end is bonded to a trialkoxysilyl group and the other end is bonded to a trialkylsilyl group or to a tris(trialkylsilyloxy)silyl group.

A more preferable mode of the compound (H) including a siloxane chain is a compound in which a molecular chain having a trialkylsilyl group and a siloxane chain (hereinafter, this molecular chain is sometimes referred to as “molecular chain (ts1)”) is bonded to at least one silicon atom (hereinafter, this silicon atom is sometimes referred to as “central silicon atom”).

In the compound (H) including a siloxane chain, the number of molecular chains (ts1) bonded to the central silicon atom is preferably 1 or more, and is preferably 3 or less, more preferably 2 or less, and particularly preferably 1.

The central silicon atom of the compound (H) including a siloxane chain may be bonded to, in addition to the molecular chain (ts1), a hydrolyzable group, a siloxane skeleton-containing group having fewer atoms than the number of atoms constituting the molecular chain (ts1), or a hydrocarbon chain-containing group containing a hydrocarbon chain having fewer carbon atoms than the number of atoms constituting the molecular chain (ts1).

Specifically, the compound (H) including a siloxane chain is preferably a compound represented by the following formula (h1).

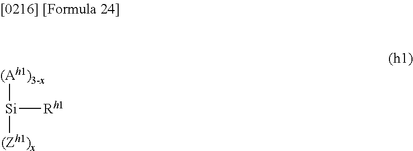

In formula (h1), R^{h1} represents a molecular chain having a trialkylsilyl group and a siloxane chain, each A^{h1} independently represents a hydrolyzable group, Z^{h1} represents a molecular chain having a trialkylsilyl group and a siloxane chain, a siloxane skeleton-containing group, or a hydrocarbon chain-containing group, a hydrogen atom included in the trialkylsilyl groups of R^{h1} and Z^{h1} is optionally replaced by a fluorine atom, and x denotes an integer of 0 to 3.

The molecular chain (molecular chain (ts1)) having a trialkylsilyl group and a siloxane chain of R^{h1} is a monovalent group having a structure in which the trialkylsilyl-containing group is bonded to an end of the siloxane chain. The alkyl group of the trialkylsilyl-containing group is optionally replaced by a fluoroalkyl group.

The trialkylsilyl-containing group is a group that includes at least one trialkylsilyl group, and includes preferably two or more trialkylsilyl groups, and more preferably three trialkylsilyl groups.

Similar to the organosilicon compound (A), the trialkylsilyl-containing group is preferably a group represented by formula (s1).

In the molecular chain (ts1), the trialkylsilyl-containing group is preferably bonded to an end (free end side) of the siloxane chain, and particularly to an end (free end side) of the main chain (longest straight chain) of the siloxane chain.

The siloxane chain to which the trialkylsilyl-containing group is bonded is the same as the siloxane chain described above, and preferably includes a straight dialkylsiloxane chain. Further, the molecular chain may include a divalent hydrocarbon group. Even if a part of the molecular chain is a divalent hydrocarbon group, the rest is a dialkylsiloxane chain, and therefore the obtained coating film has good chemical and physical durability.

The siloxane chain is preferably a group represented by formula (s2) shown above for the organosilicon compound (A).

Examples of the siloxane chain included in the molecular chain (ts1) include the molecular chain included in the trialkylsilyl group-containing molecular chain shown above for the organosilicon compound (A).

Further, the total number of atoms constituting the molecular chain (ts1) may be in the same range as the total number of atoms constituting the trialkylsilyl group-containing molecular chain shown above for the organosilicon compound (A).

The molecular chain (ts1) is preferably a group represented by formula (s3) shown above for the organosilicon compound (A).

The molecular chain (ts1) is preferably a group represented by formula (s3-1) or formula (s3-2) shown above for the organosilicon compound (A), and more preferably a group represented by formula (s3-2).

Examples of the molecular chain (ts1) include the groups represented by formula (s3-I) shown above for the organosilicon compound (A).

Next, the A^{h1} in formula (h1) will be described. A^{h1} is a hydrolyzable group and may be any group that gives a hydroxy group (silanol group) by hydrolysis. Preferable examples thereof include an alkoxy group having 1 to 6 carbon atoms, such as a methoxy group, an ethoxy group, a propoxy group, and a butoxy group; a hydroxy group; an acetoxy group; a chlorine atom; an isocyanate group; and the like. Among these, an alkoxy group having 1 to 6 carbon atoms is preferable, an alkoxy group having 1 to 4 carbon atoms is more preferable, and an alkoxy group having 1 to 2 carbon atoms is further preferable.

Z^{h1} in formula (h1) represents a molecular chain having a trialkylsilyl group and a siloxane chain, a siloxane skeleton-containing group, or a hydrocarbon chain-containing group. When Z^{h1} is a molecular chain having a trialkylsilyl group and a siloxane chain, examples of Z^{h1} include the same as those described above for R^{h1}.

When Z^{h1} is a siloxane skeleton-containing group, it is preferable that the siloxane skeleton-containing group be a monovalent group containing a siloxane unit (Si—O—), and be constituted from a fewer number of atoms than the number of atoms constituting the molecular chain (ts1) of R^{h1}. As a result, the siloxane skeleton-containing group becomes a group having a shorter length or a smaller steric size (bulk) than the molecular chain (ts1). The siloxane skeleton-containing group may include a divalent hydrocarbon group.

The siloxane skeleton-containing group is preferably a group represented by formula (s4) described above for the organosilicon compound (A).

The total number of atoms of the siloxane skeleton-containing group is preferably in the same range as the total number of atoms of the siloxane skeleton-containing group described above. Further, the difference in the number of atoms between the molecular chain (ts1) of R^{h1} and the siloxane skeleton-containing group of Z^{h1} is preferably 10 or more, and more preferably 20 or more, and is preferably 1000 or less, more preferably 500 or less, and further preferably 200 or less.

Specific examples of the siloxane skeleton-containing group include the specific groups described above as the siloxane skeleton-containing group.

When Z^{h1} is a hydrocarbon chain-containing group, it is preferable that the number of carbon atoms of the hydrocarbon chain moiety is fewer than the number of atoms constituting the molecular chain (ts1). Further, it is preferable that the number of carbon atoms of the longest straight chain of the hydrocarbon chain is fewer than the number of atoms constituting the longest straight chain of the molecular chain (ts1). Examples of the hydrocarbon chain-containing group include the same groups described above as examples of a hydrocarbon chain-containing group.

In formula (h1), x is preferably an integer of 2 or less, more preferably 0 or 1, and further preferably 0.

The compound (H) including a siloxane chain represented by formula (h1) is preferably a compound represented by formula (a2) shown above for the organosilicon compound (A). The preferred range is also the same.

The compound (H) including a siloxane chain is more preferably represented by the following formula (h3) and the following formula (h4).

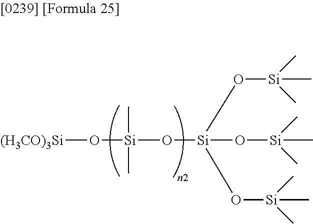

In formula (h3), n2 is an integer of 1 to 60.

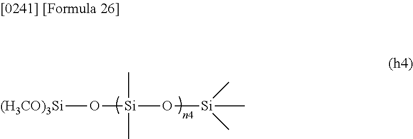

In formula (h4), n4 is an integer of 1 to 60.

It is more preferable that n2 and n4 are integers of 2 or more, and further preferably integers of 3 or more, and more preferably integers of 50 or less, further preferably integers of 45 or less, still further preferably integers of 30 or less, and particularly preferably integers of 25 or less.

By containing a predetermined amount of the compound (H) including a siloxane chain, coatability when the composition is brought into contact with the base material is improved.

Examples of the method for synthesizing the compound (H) including a siloxane chain include the methods described in Japanese Patent Laid-Open No. 2017-201009.

When the compound (H) including a siloxane chain is used in the composition for forming an intermediate layer, the amount of the compound (H) including a siloxane chain is, based on the whole composition for forming an intermediate layer of 100% by mass, for example, preferably 0.005% by mass or more, and more preferably 0.01% by mass or more, and is preferably 0.3% by mass or less, and more preferably 0.2% by mass or less.

When the compound (H) including a siloxane chain is used in the composition for forming an intermediate layer, the total amount of the polysilazane (F) and the compound (H) including a siloxane chain is, for example, based on the whole composition for forming an intermediate layer of 100% by mass, preferably 0.01% by mass or more, more preferably 0.1% by mass or more, and further preferably 0.3% by mass or more, and is preferably 5% by mass or less, more preferably 2.6% by mass or less, further preferably 2% by mass or less, and particularly preferably 1.5% by mass.

When the composition for forming an intermediate layer contains the polysilazane (F), and the metal compound (G) and the compound (H) including a siloxane chain are used, the total amount of these is, based on the whole composition for forming an intermediate layer of 100% by mass, for example, preferably 0.3% by mass or more, and more preferably 0.4% by mass or more, and is preferably 5% by mass or less, and more preferably 3% by mass or less.

The composition for forming an intermediate layer is, for example, a mixed composition which contains the polysilazane (F) and in which the metal compound (G) and/or the compound (H) including a siloxane chain are further mixed, and is obtained by mixing (F) with (G) and/or (H).

### 14. Solvent (I)

A solvent (I) may be used in the composition for forming an intermediate layer.

Examples of the solvent (I) include alcohol solvents, ether solvents, ketone solvents, ester solvents, amide solvents, aliphatic hydrocarbon solvents, aromatic hydrocarbon solvents, and the like. Examples of the alcohol solvent include, in addition to the solvents described above as examples of the solvent (E), 1-propoxy2-propanol, and the like. Examples of the ether solvent include, in addition to the solvents described above as examples of the solvent (E), dibutyl ether and the like. Examples of the ketone solvent include the solvents described above as examples of the solvent (E). Examples of the ester solvent include the solvents described above as examples of the solvent (E). Examples of the amide solvent include the solvents described above as examples of the solvent (E). Examples of the aliphatic hydrocarbon solvent include pentane, hexane, heptane, octane, isooctane, cyclopentane, cyclohexane, cycloheptane, methylcyclohexane, mineral spirits, and the like. Examples of the aromatic hydrocarbon solvent include benzene, toluene, xylene, chlorobenzene, dichlorobenzene, and the like. Among these, a ketone solvent, an ether solvent, an ester solvent, and an aliphatic hydrocarbon solvent are preferable, and an aliphatic hydrocarbon solvent is more preferable. One kind of these solvents may be used, or two or more kinds may be appropriately mixed and used. It is preferable that the solvent (I) does not contain moisture, because this allows the stability of the coating liquid to be increased, coating streakiness to be reduced, and foreign matter during coating to be reduced.

The amount of the solvent (I) is preferably, based on the whole composition for forming an intermediate layer of 100% by mass, for example, 50% by mass or more, more preferably 80% by mass or more, further preferably 90% by mass or more, and particularly preferably 95% by mass or more. The upper limit is set according to the amounts of the polysilazane (F), the metal compound (G), the compound (H) including a siloxane chain, and added components other than these (hereinafter referred to as “third component”). A component other than the polysilazane (F), metal compound (G), compound (H) including a siloxane chain, and third component may be the solvent (I).

A catalyst may coexist when preparing the composition for forming an intermediate layer.

The catalyst is preferably a catalyst capable of curing polysilazane. Examples include N-heterocyclic compounds such as 1-methylpiperazine, 1-methylpiperidine, 4,4′-trimethylenedipiperidine, 4,4′-trymethylenebis(1-methylpiperidine), diazabicyclo-[2.2.2]octane, cis-2,6-dimethylpiperazine, 4-(4-methylpiperidine)pyridine, pyridine, dipyridine, α-picoline, β-picoline, γ-picoline, piperidine, lutidine, pyrimidine, pyridazine, 4,4′-trymethylenedipyridine, 2-(methylamino)pyridine, pyrazine, quinoline, quinoxaline, triazine, pyrrole, 3-pyrroline, imidazole, triazole, tetrazole, and 1-methylpyrrolidine, amines such as methylamine, dimethylamine, trimethylamine, ethylamine, diethylamine, triethylamine, propylamine, dipropylamine, tripropylamine, butylamine, dibutylamine, tributylamine, pentylamine, dipentylamine, tripentylamine, hexylamine, dihexylamine, trihexylamine, heptylamine, diheptylamine, octylamine, dioctylamine, trioctylamine, phenylamine, diphenylamine, and triphenylamine, 1,8-diazabicyclo[5.4.0]7-undecene (DBU), 1,5-diazabicyclo[4.3.0]-5-nonene (DBN), 1,5,9-triazacyclododecane, 1,4,7-triazacyclononane, and the like.

Further, as the catalyst, in addition to the above catalysts, a catalyst that acts as a hydrolysis/condensation catalyst of a hydrolyzable group bonded to a silicon atom is also preferable. Examples of such a catalyst include: acidic compounds; basic compounds; organometallic compounds; and the like. Examples of the acidic compound include inorganic acids such as hydrochloric acid, nitric acid, sulfuric acid, phosphoric acid, hydrogen peroxide, chloric acid, and hypochloric acid; and organic acids such as acetic acid, propionic acid, butyric acid, valeric acid, maleic acid and stearic acid. Examples of the basic compound include ammonia and the like. Examples of the organometallic compound include organometallic compounds having a metal element such as Al, Fe, Zn, and Sn as a central metal, such as: organoaluminum compounds such as aluminum carboxylate, an aluminum acetylacetone complex, and an aluminum ethylacetacetate complex; organoiron compounds such as iron carboxylate (iron octylate, etc.); organozinc compounds such as zinc acetylacetonate monohydrate, zinc naphthenate, and zinc octylate; organotin compounds such as a dibutyltin diacetate complex; other organometallic compounds such as metal carboxylates including Ni, Ti, Pt, Rh, Co, Ru, Os, Pd, Ir, and the like; acetylacetonate complexes including Ni, Pt, Pd, Rh, and the like; metal fine particles of Au, Ag, Pd, Ni, Zn, Ti, and the like; metal peroxides; metal chlorides; cyclopentadienyl complexes of metals such as ferrocene and zirconosen; and the like.

The above-described additives may coexist in the composition for forming an intermediate layer in a range that does not impair the effects of the present invention.

As a method of bringing the composition for forming an intermediate layer into contact with the base material, the methods described above as examples of methods of bringing the composition for forming a liquid-repellent layer into contact with the base material can be adopted.

When the composition for forming an intermediate layer brought into contact with the base material in the manner described above is allowed to stand in the air at room temperature, it reacts with the moisture in the air, and decomposition and siloxy group formation proceed, thereby enabling a coating film containing a Si—O skeleton to be formed on the base material. The standing time is not particularly limited, but is preferably 1 minute or more, and more preferably 2 minutes or more. From the viewpoint of practicality, the standing time is preferably 12 hours or less, more preferably 1 hour or less, further preferably 30 minutes or less, and still further preferably 10 minutes or less.

The film thickness of the intermediate layer can be, for example, about 0.1 to 200 nm, preferably 0.2 to 100 nm, and more preferably 0.3 to 50 nm.

The contact angle of the droplets (specifically, water droplets) on the film obtained by curing the composition for forming a liquid-repellent layer of the present invention is preferably 95° or more, more preferably 100° or more, and further preferably 101° or more. This contact angle can be determined in accordance with the measurement method in the Examples described later.

The sliding speed of the droplets (specifically, water droplets) on the film obtained by curing the composition for forming a liquid-repellent layer of the present invention is preferably 20 mm/sec or more, more preferably 25 mm/sec or more, further preferably 30 mm/sec or more, and particularly preferably 45 mm/sec or more. This sliding speed can be determined in accordance with the measurement method in the Examples described later.

The film obtained by curing the composition for forming a liquid-repellent layer of the present invention exhibits a wear resistance of preferably 400 times or more, more preferably 1200 times or more, further preferably 1600 times or more, and particularly preferably 2000 times or more. This wear resistance can be determined in accordance with the measurement method in the Examples described later.

### EXAMPLES

Hereinafter, the present invention will be described in more detail with reference to Examples, but the present invention is not limited by the following Examples. Modifications may be made to the present invention without departing from the gist described above and below, and all of such modifications are within the technical scope of the invention. In the following, unless otherwise specified, “parts” means “parts by mass” and “%” means “% by mass”.

### (Production of Composition I for Forming an Intermediate Layer)

A composition I for forming an intermediate layer was obtained by dissolving 0.15 parts of Durazane (registered trademark) 1500 rapid cure (manufactured by MERCK), 0.09 parts of tetraethoxysilane, and 0.015 parts of the compound having an n10 average of 24 shown in Table 3-2 (A-I-26) [hereinafter referred to as “compound (1)”. molecular weight 2212.52] in 29.75 parts of isooctane. The Durazane (registered trademark) 1500 rapid cure has a structural unit represented by the following formula (f4).

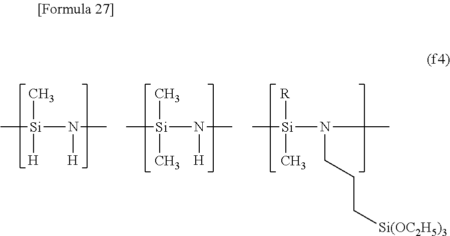

In formula (f4), R represents a hydrogen atom or a methyl group.

Durazane (registered trademark) 1500 rapid cure (manufactured by MERCK) has a Si(OC₂H₅)₃ group content of 9 to 27% by mass. Further, the molar ratio (methyl group/hydrogen atom) of the hydrogen atoms of the SiH groups to the methyl groups of the Si—CH₃ groups in the structure in (f4) was 2.39. The mass ratio of the Si(OC₂H₅)₃ groups and the molar ratio of the hydrogen atoms to the methyl groups were determined based on the integrated value of ¹H-NMR (400 MHz, reference: CDCl₃ (=7.24 ppm)). That is, the molar ratios of the SiH, SiCH₃, and Si (OCH₂CH₃)₃ in the organic polysilazane were obtained from the integrated values, and the molar ratios of the hydrogen atoms and the methyl groups were calculated. Moreover, each molar ratio was converted into a mass ratio, and the % by mass of the Si(OC₂H₅)₃ groups included in the organic polysilazane was calculated.

### (Production of Composition No. 1 for Forming a Liquid-Repellent Layer)

A sample solution 1 was obtained by dissolving 0.014 parts of compound (1) and 0.036 parts of triethoxysilane in 0.1027 parts of isopropyl alcohol, stirring at room temperature for 10 minutes, adding 0.0000733 parts of acetic acid and 0.0128 parts of water dropwise to the resultant solution, and then stirring at 65° C. for 2 hours. The obtained sample solution 1 was diluted with 46.7038 parts of isopropyl alcohol to produce composition No. 1 for forming a liquid-repellent layer. The ratio (% by mass) of each compound in composition No. 1 for forming a liquid-repellent layer is as shown in Table 5-1 below (the same applies to other Examples and Comparative Examples).

### <Coating Film No. 1>

A 5×5 cm² glass substrate (EAGLE XG, Corning Inc.) having a surface activated by an atmospheric pressure plasma treatment was placed so as to have an elevation angle of 45°, 500 μL of the composition I for forming an intermediate layer was poured from the upper surface of a glass substrate and dried at normal temperature and humidity for 5 minutes, and then 500 μL of the composition No. 1 for forming a liquid-repellent layer was poured thereon and air-dried at normal temperature and humidity for 1 day to form a coating film (intermediate layer and liquid-repellent layer) on the glass substrate.

### (Compositions No. 2 to No. 10, No. 21, and No. 22 for Forming a Liquid-Repellent Layer)

Compositions No. 2 to No. 10, No. 21, and No. 22 for forming a liquid-repellent layer were produced in the same manner as composition No. 1 for forming a liquid-repellent layer, except that the types and/or amounts of the organosilicon compound (A), the metal compound (B), the acid (C), the water (D), and the solvent (E) for composition No. 1 for forming a liquid-repellent layer were changed to those shown in Table 5-1 or Table 5-2 below.

### <Coating Films No. 2 to No. 9, No. 14, No. 21, and No. 22>

Under the same conditions as for coating film No. 1, 500 μL of the composition I for forming an intermediate layer was poured from the upper surface of a glass substrate and dried at normal temperature and humidity for 5 minutes, and then 500 μL of the compositions No. 2 to No. 10, No. 21, or No. 22 for forming a liquid-repellent layer was poured thereon and air-dried at normal temperature and humidity for 1 day to form a coating film (intermediate layer and liquid-repellent layer) on the glass substrate.

### <Coating Films No. 10 and No. 11>

Under the same conditions as for coating film No. 1 except for using the following composition II or III for forming an intermediate layer instead of composition I for forming an intermediate layer, 500 μL of the composition II or III for forming an intermediate layer was poured from the upper surface of a glass substrate and dried at normal temperature and humidity for 5 minutes, and then 500 μL of the composition No. 1 for forming a liquid-repellent layer was poured thereon and air-dried at normal temperature and humidity for 1 day to form a coating film (intermediate layer and liquid-repellent layer) on the glass substrate.

### (Production of Composition II for Forming an Intermediate Layer)

A composition II for forming an intermediate layer was obtained by dissolving 0.15 parts of Durazane (registered trademark) 1500 rapid cure (manufactured by MERCK) and 0.015 parts of the compound (1) in 29.84 parts of isooctane.

### (Production of Composition III for Forming an Intermediate Layer)

A composition III for forming an intermediate layer was obtained by dissolving 0.15 parts of Durazane (registered trademark) 1500 rapid cure (manufactured by MERCK) and 0.09 parts of triethoxysilane in 29.84 parts of isooctane.

### <Coating Films No. 12 and 13>

A 5×5 cm² glass substrate (EAGLE XG, Corning Inc.) having a surface activated by an atmospheric pressure plasma treatment was placed so as to have an elevation angle of 45°, 500 μL of the compositions No. 1 or No. 4 for forming a liquid-repellent layer was poured thereon and air-dried at normal temperature and humidity for 1 day to form a coating film (liquid-repellent layer) on the glass substrate.

TABLE 5-1

| | | | Compound No. for forming a liquid-repellent layer No. | | | | | | |
|---|---|---|---|---|---|---|---|---|---|
| | | | 1 | 2 | 3 | 4 | 5 | 6 | 7 |
| Organosilicon | Compound (1) | parts | 0.014 | 0.014 | 0.014 | 0.014 | 0.014 | 0.014 | 0.011 |
| compound (A) | | % by mass | 0.029 | 0.029 | 0.029 | 0.029 | 0.029 | 0.029 | 0.023 |
| Metal compound (B) | Tetraethoxysilane | parts | | | | | | | 0.036 |
| | | % by mass | | | | | | | 0.077 |
| | Triethoxysilane | parts | 0.036 | 0.036 | 0.036 | 0.036 | 0.036 | 0.036 | |
| | | % by mass | 0.077 | 0.076 | 0.076 | 0.076 | 0.076 | 0.076 | |
| Total of organosilicon compound (A) + | | % by mass | 0.106 | 0.106 | 0.106 | 0.105 | 0.105 | 0.106 | 0.100 |
| metal compound (B) | | mmol | 0.0022 | 0.0022 | 0.0022 | 0.0022 | 0.0022 | 0.0022 | 0.0018 |
| Metal compound (B)/Organosilicon | | molar ratio | 35 | 35 | 35 | 35 | 35 | 35 | 35 |
| compound (A) | | | | | | | | | |
| Acid (C) | Acetic acid | parts | 0.0000773 | 0.0000773 | 0.0000773 | 0.0000773 | 0.0000773 | 0.0000773 | |
| | | % by mass | 0.000165 | 0.000165 | 0.000165 | 0.000164 | 0.000164 | 0.000165 | |
| | Malonic acid | parts | | | | | | | |
| | | % by mass | | | | | | | |
| | Maleic acid | parts | | | | | | 0.002 | 0.0025 |
| | | % by mass | | | | | | 0.00396 | 0.00541 |
| | Hydrochloric acid | parts | | | | | | | |
| | | % by mass | | | | | | | |
| Total of acid (C) | | % by mass | 0.000165 | 0.000165 | 0.000165 | 0.000164 | 0.000164 | 0.00413 | 0.00541 |
| Water (D) | | parts | 0.013 | 0.085 | 0.128 | 0.256 | 0.383 | 0.085 | 0.010 |
| | | % by mass | 0.027 | 0.181 | 0.272 | 0.542 | 0.811 | 0.181 | 0.022 |
| Solvent (E) | Isopropyl alcohol | parts | 46.8065 | 46.8065 | 46.8065 | 46.8065 | 46.8065 | 46.8065 | 46.8105 |
| | | % by mass | 99.87 | 99.71 | 99.62 | 99.35 | 99.08 | 99.71 | 99.87 |

| | | | | | | | | |
|---|---|---|---|---|---|---|---|---|
| Water (D)/[Organosilicon compound | molar ratio | 3.1663 | 21.0727 | 31.6091 | 63.2182 | 94.8273 | 21.0727 | 3.1721 |
| (A) + Metal compound (B)] | | | | | | | | |
| Water (D)/[Organosilicon compound | mass ratio | 0.2577 | 1.7152 | 2.5729 | 5.1457 | 7.7186 | 1.7152 | 0.2163 |
| (A) + Metal compound (B)] | | | | | | | | |

TABLE 5-2

| | | | Compound No. for forming a liquid-repellent layer No. | | | | |
|---|---|---|---|---|---|---|---|
| | | | 8 | 9 | 10 | 21 | 22 |
| Organosilicon compound (A) | Compound (1) | parts | 0.011 | 0.077 | 0.014 | 0.011 | 0.012 |
| | | % by mass | 0.023 | 0.242 | 0.029 | 0.023 | 0.120 |
| Metal compound (B) | Tetraethoxysilane | parts | 0.036 | 0.252 | | 0.036 | 0.0165 |
| | | % by mass | 0.077 | 0.797 | | 0.076 | 0.165 |
| | Triethoxysilane | parts | | | 0.036 | | |
| | | % by mass | | | 0.076 | | |
| Total of organosilicon compound (A) + | | % by mass | 0.100 | 1.038 | 0.105 | 0.099 | 0.285 |
| metal compound (B) | | mmol | 0.0018 | 0.0125 | 0.0022 | 0.0018 | 0.0008 |
| Metal compound (B)/Organosilicon | | molar ratio | 35 | 35 | | 35 | 15 |
| compound (A) | | | | | | | |
| Acid (C) | Acetic acid | parts | | | 0.0000773 | | |
| | | % by mass | | | 0.000163 | | |
| | Malonic acid | parts | | | | | 0.0014 |
| | | % by mass | | | | | 0.014 |
| | Maleic acid | parts | 0.0051 | 0.0356 | | 0.015 | |
| | | % by mass | 0.0108 | 0.11229 | | 0.0321 | |
| | Hydrochloric acid | parts | | | | | 0.00007785 |
| | | % by mass | | | | | 0.0007785 |
| Total of acid (C) | | % by mass | 0.01079 | 0.11229 | 0.00016 | 0.0321 | 0.01478 |
| Water (D) | | parts | 0.109 | 0.409 | 0.511 | 0.50 | 0.208 |
| | | % by mass | 0.232 | 1.291 | 1.079 | 1.065 | 2.075 |
| Solvent (E) | Isopropyl alcohol | parts | 46.8105 | 30.9022 | 46.8065 | 46.8105 | 9.7625 |
| | | % by mass | 99.66 | 97.56 | 98.82 | 98.88 | 97.63 |

| | | | | | | |
|---|---|---|---|---|---|---|
| Water (D)/[Organosilicon compound (A) + Metal | molar ratio | 34.1005 | 18.2398 | 126.4364 | 157.8142 | 136.2365 |
| compound (B)] | | | | | | |
| Water (D)/[Organosilicon compound (A) + Metal | mass ratio | 2.3253 | 1.2438 | 10.2914 | 10.7676 | 7.2815 |
| compound (B)] | | | | | | |

The properties of the coating films No. 1 to No. 14, No. 21, and 22 were evaluated as follows.

### (Contact Angle)

The contact angle of the coating film surface was measured by a θ/2 method as the analysis method with a water droplet amount of 3.0 μL using a contact angle measuring device “DM700” manufactured by Kyowa Interface Science Co., Ltd. Cases in which the contact angle was 95° or more were evaluated as having excellent water repellency.

### (Sliding Speed)

Water was dropped onto the coating film surface, and water repellency was evaluated by the sliding speed of the water droplets on the coating film surface. Specifically, using a contact angle measuring device “DM700” manufactured by Kyowa Interface Science Co., Ltd., 50 μL of water was dropped onto a coating film surface on a substrate tilted at 20°, the time taken for the water droplet to slide 15 mm from the initial dropping position was measured, and the sliding speed (mm/sec) of the water droplet on the coating film surface was calculated. In cases where the dropped water droplet did not slide down by 15 mm or more from the initial dropping position within 2 minutes, the dropped water droplet was determined to not have slid down, and the sliding speed was taken as 0.0 mm/sec. Cases where the sliding speed of the water droplet was 20 mm/sec or more were evaluated as having excellent water repellency.

### (Wear Resistance)

Onto a coating film 2.5 mL of water was dropped, and a silicon sheet (SR-400, manufactured by Tigers Polymer Corporation) was brought into contact thereon. In that state, a load of 500 gf was applied to the silicon sheet. Then, under conditions of a reciprocating speed of 400 mm/min, the coating films were rubbed of a distance of 20 mm 400 times. The contact angles at three points in the center of the rubbed portion were each measured, and the number of times until two of the three points decreased to 85° or less was measured. When the number of times was 400 times or more, the wear resistance was evaluated to be excellent.

The evaluation results of the properties of the obtained coating films are shown in Table 6-1 or Table 6-2.

TABLE 6-1

| | Coating film No. | | | | | | | |
|---|---|---|---|---|---|---|---|---|
| | 1 | 2 | 3 | 4 | 5 | 6 | 7 | 8 |
| Composition No. for forming an | I | I | I | I | I | I | I | I |
| intermediate film No. | | | | | | | | |
| Compound No. for forming a liquid- | 1 | 2 | 3 | 4 | 5 | 6 | 7 | 8 |
| repellent layer No. | | | | | | | | |
| Contact angle (°) | 102.1 | 101.8 | 101.7 | 102.1 | 102.0 | 102.2 | 100.1 | 100.7 |
| Sliding speed (mm/sec) | 49.0 | 55.1 | 91.8 | 75.9 | 78.7 | 67.7 | 26.6 | 48.8 |
| Number of rubs | 1200 | 1600 | 2400 | 2000 | 1600 | 3200 | 1600 | 1600 |

TABLE 6-2

| | Coating film No. | | | | | | | |
|---|---|---|---|---|---|---|---|---|
| | 9 | 10 | 11 | 12 | 13 | 14 | 21 | 22 |
| Composition No. for forming an | I | II | III | — | — | I | I | I |
| intermediate film No. | | | | | | | | |
| Compound No. for forming a liquid- | 9 | 1 | 1 | 1 | 4 | 10 | 21 | 22 |
| repellent layer No. | | | | | | | | |
| Contact angle (°) | 103.4 | 103 | 102.1 | 101 | 101 | 102.4 | 100.1 | 93.0 |
| Sliding speed (mm/sec) | 49.0 | 86.5 | 65.3 | 23.6 | 8.6 | 64.7 | 63.7 | 0.0 |
| Number of rubs | 1600 | 2000 | 1200 | 800 | 400 | 1200 | 400> | 400> |

In coating films No. 1 to No. 14, since the liquid-repellent layer was formed using a composition (composition for forming a liquid-repellent layer) satisfying the requirements specified in the present invention, a coating film having excellent wear resistance could be produced without impairing water repellency. Particularly compared with the coating films No. 12 and No. 13, coating films No. 1 to No. 11 and No. 14 had relatively good water repellency and wear resistance. In addition, in coating films No. 1 to No. 11 and No. 14, on the base material, since the liquid-repellent layer was formed after an intermediate layer was formed using a composition which contained polysilazane (F) and in which the metal compound (G) and/or compound (H) including a siloxane chain and solvent (I) were further mixed, the liquid-repellent layer was cured at room temperature, and had excellent in room temperature curability.

### INDUSTRIAL APPLICABILITY

A coating film obtained using the composition for forming a liquid-repellent layer of the present invention has excellent water and oil repellency, and excellent wear resistance. Therefore, a base material treated using the composition for forming a liquid-repellent layer of the present invention is useful as a base material in display devices such as touch panel displays, optical elements, semiconductor devices, building materials, automobile parts, and nanoimprint technology. In addition, a coating formed from the composition for forming a liquid-repellent layer of the present invention can be suitably used for articles such as a body in transportation machinery, such as trains, automobiles, ships, and aircraft, window glass (windshields, side windows, rear windows), mirrors, and bumpers. Furthermore, the composition for forming a liquid-repellent layer of the present invention can also be used for outdoor applications such as the external walls of a building, tents, solar power generation modules, sound insulation boards, and concrete, as well as for fishing nets, insect nets, aquariums, and the like. Still further, the composition for forming a liquid-repellent layer of the present invention can be used for a part of various members in kitchens, bathrooms, washbasins, mirrors, toilet vicinity, as well as for various indoor equipment such as chandeliers, ceramics such as tiles, artificial marble, and air conditioners. Still further, the composition for forming a liquid-repellent layer of the present invention can also be used as an antifouling treatment for jigs, inner walls, pipes, and the like in factories. Still further, the composition for forming a liquid-repellent layer of the present invention is also suitable for goggles, spectacles, helmets, pachinko (mechanical gaming machine) equipment, textiles, umbrellas, playground equipment, soccer balls and the like. Still further, the composition for forming a liquid-repellent layer of the present invention can be used as an anti-adhesive agent for various packaging materials, such as food packaging materials, cosmetic packaging materials, and pot interiors.

1. A mixed composition comprising:
an organosilicon compound (A) in which at least one trialkylsilyl group-containing molecular chain and at least one hydrolyzable group are bonded to a silicon atom;
a metal compound (B);
an acid (C); and
water (D), wherein
a ratio [D/(A+B)] of a molar amount of the water (D) to a total molar amount of the organosilicon compound (A) and the metal compound (B) is 3.1 to 130.

2. The composition according to claim 1, wherein the amount of the water (D) is 0.01 to 2.0% by mass.

3. The composition according to claim 1, wherein the organosilicon compound (A) is a compound represented by the following formula (a1): 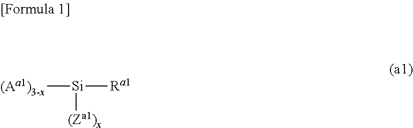
wherein each of a plurality of A^{a1} independently represent a hydrolyzable group,
Z^{a1} represents a trialkylsilyl group-containing molecular chain, a siloxane skeleton-containing group, or a hydrocarbon chain-containing group,
x is 0 or 1,
R^{a1} represents a trialkylsilyl group-containing molecular chain, and
a hydrogen atom included in the trialkylsilyl groups of Z^{a1} and R^{a1} is optionally replaced by a fluorine atom.

4. The mixed composition according to claim 1, wherein the organosilicon compound (A) is a compound represented by the following formula (a2): 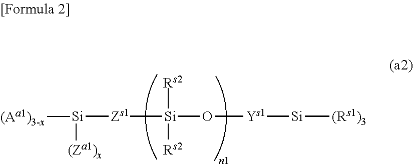
wherein A^{a1}, Z^{a1}, and x have the same meaning as described above,
Z^{s1} represents —O— or a divalent hydrocarbon group, —CH₂— included in the divalent hydrocarbon group is optionally replaced by —O—,
each of a plurality of R^{s2} independently represents an alkyl group having 1 to 10 carbon atoms,
n1 is an integer of 1 or more,
Y^{s1} represents a single bond or —Si(R^{s2})₂-L^{s1}-, the L^{s1} represents a divalent hydrocarbon group, —CH₂— included in the divalent hydrocarbon group is optionally replaced by —O—, and each of a plurality of R^{s1} independently represents a hydrocarbon group or a trialkylsilyloxy group.

5. The mixed composition according to claim 1, wherein the metal compound (B) is a compound represented by the following formula (b1):
M(R^{b10})ᵣ(A^{b})ₘ₋ᵣ (b1)
wherein M represents Al, Fe, In, Ge, Hf, Si, Ti, Sn, Zr, or Ta,
R^{b10} represents a silozane skeleton-containing group, a hydrocarbon chain-containing group, or a hydrogen atom,
r is 0 or 1,
a plurality of A^{b1} each independently represent a hydrolyzable group, and
m, which is a valence of the metal atom M, denotes an integer selected from 3 to 5.

6. The mixed composition according to claim 1, wherein the metal compound (B) is a compound represented by the following formula (b2):
Si(OR^{b11})_{y}H_{4-y} (b2)
wherein R^{b11} represents an alkyl group having 1 to 6 carbon atoms, and y is 3 or 4.

7. The mixed composition according to claim 1, comprising a solvent (E), wherein an amount of the solvent (E) is 10% by mass or more.
